(19) United States
(12) Patent Application Publication
(10) Pub. No.: US 2025/0247667 A1
(43) Pub. Date: Jul. 31, 2025

(54) ACOUSTIC PROCESSING METHOD, ACOUSTIC PROCESSING DEVICE, AND RECORDING MEDIUM

(71) Applicant: Panasonic Intellectual Property Corporation of America, Torrance, CA (US)

(72) Inventors: Seigo ENOMOTO, Kyoto (JP); Tomokazu Ishikawa, Osaka (JP); Hikaru Usami, Osaka (JP); Kota Nakahashi, Osaka (JP); Hiroyuki Ehara, Kanagawa (JP); Mariko Yamada, Hyogo (JP); Shuji Miyasaka, Osaka (JP)

(21) Appl. No.: 19/180,555

(22) Filed: Apr. 16, 2025

Related U.S. Application Data
(63) Continuation of application No. PCT/JP2023/035546, filed on Sep. 28, 2023.
(60) Provisional application No. 63/417,398, filed on Oct. 19, 2022.

(51) Int. Cl. H04S 7/00

(52) U.S. Cl. CPC H04S 7/304; H04S 2400/11; H04S 2400/15

(57) ABSTRACT

An information processing method includes: obtaining an audio signal generated by collecting sound emitted from a sound source using a sound collection device; executing, on the audio signal, acoustic processing that repeatedly changes a relative position between the sound collection device and the sound source in a time domain; and outputting an output audio signal on which the acoustic processing has been executed.

### CROSS REFERENCE TO RELATED APPLICATIONS

This is a continuation application of PCT International Application No. PCT/JP2023/035546 filed on Sep. 28, 2023, designating the United States of America, which is based on and claims priority of U.S. Provisional Patent Application No. 63/417,398 filed on Oct. 19, 2022. The entire disclosures of the above-identified applications, including the specifications, drawings, and claims are incorporated herein by reference in their entirety.

### FIELD

The present disclosure relates to an acoustic processing method, an acoustic processing device, and a recording medium.

### BACKGROUND

Techniques for acoustic reproduction to make a user perceive three-dimensional sound in a virtual three-dimensional space are known (see, for example, Patent Literature (PTL) 1). In order to make the sound be perceived as arriving from sound source object to the user in such a three-dimensional space, processing is required to generate output sound information from the original sound information. Here, acoustic processing may be performed to increase the sense of sound localization in order to make the user listening to the sound feel a greater sense of realism in the three-dimensional space. For example, an acoustic processing device that provides a sense of localization such that sound is perceived as coming from the direction of sound source coordinates input from a coordinate fluctuation adding device is known (see PTL 1).

### CITATION LIST

### Patent Literature

PTL 1: Japanese Unexamined Patent Application Publication No. 2005-295416

### SUMMARY

### Technical Problem

When adding fluctuations to increase the sense of sound localization, there may be cases where the acoustic processing for adding such fluctuations cannot be executed appropriately. The present disclosure thus describes an acoustic processing method and the like for executing acoustic processing more appropriately.

### Solution to Problem

An acoustic processing method according to one aspect of the present disclosure includes: obtaining an audio signal generated by collecting sound emitted from a sound source using a sound collection device; executing, on the audio signal, acoustic processing that repeatedly changes a relative position between the sound collection device and the sound source in a time domain; and outputting an output audio signal on which the acoustic processing has been executed.

An acoustic processing method according to another aspect of the present disclosure is an acoustic processing method for outputting an output audio signal that causes a sound emitted from a sound source object in a virtual sound space to be perceived as if heard at a listening point in the virtual sound space, and includes: obtaining an audio signal including the sound emitted from the sound source object; receiving an instruction to change a relative position between the listening point and the sound source object, including a first amount of change by which the relative position changes according to the instruction; executing, on the audio signal, acoustic processing that changes the relative position by the first amount of change, and repeatedly changes the relative position in a time domain by a second amount of change; and outputting the output audio signal on which the acoustic processing has been executed.

An acoustic processing device according to one aspect of the present disclosure includes: an obtainer that obtains an audio signal generated by collecting sound emitted from a sound source using a sound collection device; a processor that executes, on the audio signal, acoustic processing that repeatedly changes a relative position between the sound collection device and the sound source in a time domain; and an outputter that outputs an output audio signal on which the acoustic processing has been executed.

An acoustic processing device according to another aspect of the present disclosure is for outputting an output audio signal that causes a sound emitted from a sound source object in a virtual sound space to be perceived as if heard at a listening point in the virtual sound space, and includes: an obtainer that obtains an audio signal including the sound emitted from the sound source object; an input interface that receives an instruction to change a relative position between the listening point and the sound source object, including a first amount of change by which the relative position changes according to the instruction; a processor that executes, on the audio signal, acoustic processing that changes the relative position by the first amount of change, and repeatedly changes the relative position in a time domain by a second amount of change; and an outputter that outputs the output audio signal on which the acoustic processing has been executed.

One aspect of the present disclosure may be realized as a non-transitory computer-readable recording medium for use in a computer, the recording medium having a computer program recorded thereon for causing the computer to execute an acoustic processing method described above.

Note that these general or specific aspects may be implemented using a system, a device, a method, an integrated circuit, a computer program, or a non-transitory computer-readable recording medium such as a CD-ROM, or any combination thereof.

### Advantageous Effects

The present disclosure makes it possible to execute acoustic processing more appropriately.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating an example of use of an acoustic reproduction system according to an embodiment of the present disclosure.

FIG. 2A is a diagram for explaining an example of use of an acoustic reproduction system according to an embodiment of the present disclosure.

FIG. 2B is a diagram for explaining an example of use of an acoustic reproduction system according to an embodiment of the present disclosure.

FIG. 3 is a block diagram illustrating the functional configuration of an acoustic reproduction system according to an embodiment of the present disclosure.

FIG. 4 is a block diagram illustrating the functional configuration of an obtainer according to an embodiment of the present disclosure.

FIG. 5 is a block diagram illustrating the functional configuration of a processor according to an embodiment of the present disclosure.

FIG. 6 is a diagram for explaining another example of an acoustic reproduction system according to an embodiment of the present disclosure.

FIG. 7 is a diagram for explaining another example of an acoustic reproduction system according to an embodiment of the present disclosure.

FIG. 8 is a diagram for explaining another example of an acoustic reproduction system according to an embodiment of the present disclosure.

FIG. 9 is a diagram for explaining another example of an acoustic reproduction system according to an embodiment of the present disclosure.

FIG. 10 is a diagram for explaining another example of an acoustic reproduction system according to an embodiment of the present disclosure.

FIG. 11 is a diagram for explaining another example of an acoustic reproduction system according to an embodiment of the present disclosure.

FIG. 12 is a diagram for explaining another example of an acoustic reproduction system according to an embodiment of the present disclosure.

FIG. 13 is a diagram for explaining another example of an acoustic reproduction system according to an embodiment of the present disclosure.

FIG. 14 is a diagram for explaining another example of an acoustic reproduction system according to an embodiment of the present disclosure.

FIG. 15 is a diagram for explaining another example of an acoustic reproduction system according to an embodiment of the present disclosure.

FIG. 16 is a flowchart illustrating operations performed by an acoustic processing device according to an embodiment of the present disclosure.

FIG. 17 is a diagram for explaining frequency characteristics of acoustic processing according to an embodiment of the present disclosure.

FIG. 18 is a diagram for explaining the magnitude of fluctuation in acoustic processing according to an embodiment of the present disclosure.

FIG. 19 is a diagram for explaining the period and angle of fluctuation in acoustic processing according to an embodiment of the present disclosure.

FIG. 20 is a block diagram illustrating the functional configuration of a processor according to another example of an embodiment of the present disclosure.

FIG. 21 is a flowchart illustrating operations performed by an acoustic processing device according to another example of an embodiment of the present disclosure.

### DESCRIPTION OF EMBODIMENTS

### Underlying Knowledge Forming Basis of the Disclosure

Techniques for acoustic reproduction to make a user perceive three-dimensional sound in a virtual three-dimensional space (hereinafter may be referred to as a three-dimensional sound field or virtual sound space) are known (see, for example, PTL 1). By using this technique, the user can perceive the sound as if a sound source object is at a predetermined position in the virtual space and the sound is arriving from that direction. In order to localize a sound image at a predetermined position in a virtual three-dimensional space in this way, for example, computational processing is required to generate interaural time differences and interaural level differences (or sound pressure differences) between the ears for the signal of the sound from the sound source object, such that the sound is perceived as a three-dimensional sound. Such computational processing is performed by applying a three-dimensional sound filter. A three-dimensional sound filter is an information processing filter that, when applied to the original sound information and the resulting output sound signal is reproduced, allows the direction and distance of the sound, the size of the sound source, and the spaciousness to be perceived three-dimensionally.

As one example of computational processing for applying such a three-dimensional sound filter, processing that convolves a head-related transfer function for perceiving sound as arriving from a predetermined direction with the signal of the target sound is known. Performing the convolution processing of this head-related transfer function at sufficiently fine angles with respect to the sound arrival direction from the position of the sound source object to the user position enhances the sense of realism experienced by the user.

In recent years, development of technology related to virtual reality (VR) has been actively conducted. In virtual reality, acoustic processing may be executed to increase the sense of sound localization, as the sense of sound localization in the three-dimensional sound field also contributes to the sense of realism of the images. When adding fluctuations to increase the sense of sound localization, from the perspective of effectiveness, it is not necessary to uniformly add fluctuations to all sounds. Stated differently, there exist conditions under which the addition of fluctuations acts effectively. It can be said to be preferable to add fluctuations only when such conditions are met, as this eliminates the need to unnecessarily prepare processing resources.

A more specific overview of the present disclosure is as follows.

An acoustic processing method according to a first aspect of the present disclosure includes: obtaining an audio signal generated by collecting sound emitted from a sound source using a sound collection device; executing, on the audio signal, acoustic processing that repeatedly changes a relative position between the sound collection device and the sound source in a time domain; and outputting an output audio signal on which the acoustic processing has been executed.

According to this acoustic processing method, in cases where there is a condition that results in a loss of sense of realism, such as when the placement position of the sound collection device does not change relative to the position of the sound source, as in an audio signal collected using a sound collection device, it is possible to reproduce the lost sense of realism by adding fluctuation through acoustic processing that repeatedly changes the relative position between the sound collection device and the sound source in the time domain. In this way, it becomes possible to execute acoustic processing more appropriately from the perspective of reproducing a sense of realism.

An acoustic processing method according to a second aspect is the acoustic processing method according to the first aspect, wherein the executing includes: determining whether a change in sound pressure in the time domain of the audio signal satisfies a predetermined condition regarding the change; executing the acoustic processing when the predetermined condition is determined to be satisfied; and skipping the acoustic processing when the predetermined condition is determined not to be satisfied.

According to this acoustic processing method, the execution of acoustic processing can be varied based on whether a predetermined condition regarding the change in sound pressure in the time domain of the audio signal is satisfied.

An acoustic processing method according to a third aspect is the acoustic processing method according to the first or second aspect, wherein the executing includes: estimating a positional relationship between the sound collection device and the sound source using the audio signal; determining whether the positional relationship estimated satisfies a predetermined condition regarding the positional relationship; executing the acoustic processing when the predetermined condition is determined to be satisfied; and skipping the acoustic processing when the predetermined condition is determined not to be satisfied.

According to this acoustic processing method, the execution of acoustic processing can be varied based on whether a predetermined condition regarding the positional relationship between the sound collection device and the sound source estimated using the audio signal is satisfied.

An acoustic processing method according to a fourth aspect is the acoustic processing method according to any one of the first to third aspects, wherein the audio signal includes sound collection situation information regarding a condition at time of sound collection, and the executing includes: determining whether the sound collection situation information included in the audio signal satisfies a predetermined condition regarding the sound collection situation information; executing the acoustic processing when the predetermined condition is determined to be satisfied; and skipping the acoustic processing when the predetermined condition is determined not to be satisfied.

According to this acoustic processing method, the execution of acoustic processing can be varied based on whether a predetermined condition regarding the sound collection situation information included in the audio signal is satisfied.

An acoustic processing method according to a fifth aspect is the acoustic processing method according to any one of the first to fourth aspects, wherein the executing includes: estimating a positional relationship between the sound collection device and the sound source using the audio signal; and executing the acoustic processing under a processing condition dependent on the positional relationship estimated.

According to this acoustic processing method, acoustic processing can be executed under processing conditions that are dependent on the positional relationship between the sound collection device and the sound source estimated using the audio signal.

An acoustic processing method according to a sixth aspect is an acoustic processing method for outputting an output audio signal that causes a sound emitted from a sound source object in a virtual sound space to be perceived as if heard at a listening point in the virtual sound space, and includes: obtaining an audio signal including the sound emitted from the sound source object; receiving an instruction to change a relative position between the listening point and the sound source object, including a first amount of change by which the relative position changes according to the instruction; executing, on the audio signal, acoustic processing that changes the relative position by the first amount of change, and repeatedly changes the relative position in a time domain by a second amount of change; and outputting the output audio signal on which the acoustic processing has been executed.

According to this acoustic processing method, when causing a sound emitted from a sound source object in a virtual sound space to be perceived as if heard at a listening point in the virtual sound space, in addition to the change in relative position between the listening point and the sound source object based on the first amount of change according to an instruction to change the relative position, in cases where the sense of realism has already been lost in the audio signal, it is possible to reproduce the lost sense of realism by adding fluctuation through acoustic processing that repeatedly changes the relative position between the listening point and the sound source object in the time domain by a second amount of change. In this way, it becomes possible to execute acoustic processing more appropriately from the perspective of reproducing a sense of realism.

An acoustic processing method according to a seventh aspect is the acoustic processing method according to the sixth aspect, wherein the sound source object simulates a user in a real space, the acoustic processing method further includes obtaining a detection result from a sensor provided in the real space that detects the user, and the second amount of change is calculated based on the detection result.

According to this acoustic processing method, the second amount of change can be calculated based on the detection result obtained from a sensor that detects the user in the real space corresponding to the sound source object.

An acoustic processing method according to an eighth aspect is the acoustic processing method according to the sixth aspect, wherein the sound source object simulates a user in a real space, the acoustic processing method further includes obtaining a detection result from a sensor provided in the real space that detects the user, and the second amount of change is calculated independently of the detection result.

According to this acoustic processing method, the second amount of change can be calculated independently of the detection result obtained from a sensor that detects the user in the real space corresponding to the sound source object.

An acoustic processing method according to a ninth aspect is the acoustic processing method according to the sixth aspect, wherein the second amount of change is calculated independently of the first amount of change.

According to this acoustic processing method, the second amount of change can be calculated independently of the first amount of change.

An acoustic processing method according to a tenth aspect is the acoustic processing method according to the sixth aspect, wherein the second amount of change is calculated to increase as the first amount of change increases.

According to this acoustic processing method, a second amount of change can be calculated to increase as the first amount of change increases.

An acoustic processing method according to an eleventh aspect is the acoustic processing method according to the sixth aspect, wherein the second amount of change is calculated to increase as the first amount of change decreases.

According to this acoustic processing method, a second amount of change can be calculated to increase as the first amount of change decreases.

An acoustic processing method according to a twelfth aspect is the acoustic processing method according to any one of the first to eleventh aspects, further including: obtaining control information for the audio signal, wherein in the executing, the acoustic processing is executed when the control information indicates to execute the acoustic processing.

According to this acoustic processing method, acoustic processing can be executed when the obtained control information indicates to execute the acoustic processing.

An acoustic processing device according to a thirteenth aspect of the present disclosure includes: an obtainer that obtains an audio signal generated by collecting sound emitted from a sound source using a sound collection device; a processor that executes, on the audio signal, acoustic processing that repeatedly changes a relative position between the sound collection device and the sound source in a time domain; and an outputter that outputs an output audio signal on which the acoustic processing has been executed.

According to this acoustic processing device, advantageous effects similar to those of the acoustic processing methods described above can be achieved.

An acoustic processing device according to a fourteenth aspect of the present disclosure is for outputting an output audio signal that causes a sound emitted from a sound source object in a virtual sound space to be perceived as if heard at a listening point in the virtual sound space, and includes: an obtainer that obtains an audio signal including the sound emitted from the sound source object; an input interface that receives an instruction to change a relative position between the listening point and the sound source object, including a first amount of change by which the relative position changes according to the instruction; a processor that executes, on the audio signal, acoustic processing that changes the relative position by the first amount of change, and repeatedly changes the relative position in a time domain by a second amount of change; and an outputter that outputs the output audio signal on which the acoustic processing has been executed.

According to this acoustic processing device, advantageous effects similar to those of the acoustic processing methods described above can be achieved.

Furthermore, these general or specific aspects may be implemented using a system, a device, a method, an integrated circuit, a computer program, or a non-transitory computer-readable recording medium such as a CD-ROM, or any combination thereof.

Hereinafter, one or more embodiments will be described in detail with reference to the drawings. Each embodiment described below presents a general or specific example. The numerical values, shapes, materials, elements, the arrangement and connection of the elements, steps, the processing order of the steps etc., shown in the following embodiment are mere examples, and do not limit the scope of the present disclosure. Among the elements described in the following one or more embodiments, those not recited in any of the independent claims are described as optional elements. Moreover, the figures are schematic diagrams and are not necessarily precise illustrations. In the figures, elements that are essentially the same share the same reference signs, and repeated description may be omitted or simplified.

In the following description, ordinal numbers such as first, second, and third may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

### Embodiment

### Overview

First, an overview of an acoustic reproduction system according to an embodiment will be described. FIG. 1 is a schematic diagram illustrating an example of use of an acoustic reproduction system according to an embodiment. FIG. 1 illustrates user 99 using acoustic reproduction system 100.

Acoustic reproduction system 100 illustrated in FIG. 1 is used simultaneously with stereoscopic image reproduction device 200. By simultaneously viewing stereoscopic images and listening to three-dimensional sound, the images enhance the auditory sense of realism, and the sound enhances the visual sense of realism, allowing one to experience as if being at the scene where the images and sound were captured. For example, when an image (moving image) of people having a conversation is displayed, even if the localization of the sound image of the conversation sound is misaligned with the person's mouth, it is known that user 99 perceives it as conversation sound emitted from the person's mouth. In this manner, by combining images and sound, the position of the sound image may be corrected by visual information, thereby enhancing the sense of realism.

Stereoscopic image reproduction device 200 is an image display device worn on the head of user 99. Accordingly, stereoscopic image reproduction device 200 moves integrally with the head of user 99. For example, stereoscopic image reproduction device 200 is, as illustrated in the figure, a glasses-type device supported by the ears and nose of user 99.

Stereoscopic image reproduction device 200 changes the image to be displayed in response to the movement of the head of user 99, to cause user 99 to perceive as if he or she is moving their head within a three-dimensional image space. Stated differently, when an object within the three-dimensional image space is positioned in front of user 99, if user 99 turns to the right, the object moves to the left direction of user 99, and if user 99 turns to the left, the object moves to the right direction of user 99. Thus, stereoscopic image reproduction device 200 moves the three-dimensional image space in the opposite direction to the movement of user 99.

Stereoscopic image reproduction device 200 displays two images, each with a parallax shift, one to the left eye and the other to the right eye of user 99. User 99 can perceive the three-dimensional position of an object in the image based on the parallax shift of the displayed image. Note that when acoustic reproduction system 100 is used for the reproduction of healing sounds to induce sleep, or when user 99 uses it with their eyes closed, stereoscopic image reproduction device 200 does not need to be used simultaneously. Stated differently, stereoscopic image reproduction device 200 is not an essential element of the present disclosure. In addition to dedicated image display devices, there are cases where general-purpose portable terminals such as smartphones and tablet devices owned by user 99 are used for stereoscopic image reproduction device 200.

Such general-purpose portable terminals include various sensors for detecting the posture and movement of the terminal, in addition to a display for displaying images. Such general-purpose portable terminals also include a processor for information processing, enabling connection to a network for sending and receiving information with server devices such as cloud servers. Stated differently, stereoscopic image reproduction device 200 and acoustic reproduction system 100 can also be implemented by a combination of a smartphone and general-purpose headphones without information processing functions.

As in this example, the function for detecting head movement, the function for presenting images, the image information processing function for presentation, the function for presenting sound, and the sound information processing function for presentation may be appropriately arranged in one or more devices to implement stereoscopic image reproduction device 200 and acoustic reproduction system 100. When stereoscopic image reproduction device 200 is unnecessary, it suffices to appropriately arrange the function for detecting head movement, the function for presenting sound, and the sound information processing function for presentation in one or more devices. For example, acoustic reproduction system 100 can also be implemented by a processing device such as a computer or smartphone that includes the sound information processing function for presentation, and headphones or the like that include the function for detecting head movement and the function for presenting sound.

Acoustic reproduction system 100 is an audio presentation device worn on the head of user 99. Accordingly, acoustic reproduction system 100 moves integrally with the head of user 99. For example, acoustic reproduction system 100 according to the present embodiment is what is known as an over-ear headphone device. Note that the embodiment of acoustic reproduction system 100 is not particularly limited and may be, for example, two in-ear devices independently worn on the left and right ears of user 99.

Acoustic reproduction system 100 changes the sound to be presented in response to the movement of the head of user 99, to cause user 99 to perceive as if he or she is moving their head within a three-dimensional sound field. Thus, as described above, acoustic reproduction system 100 moves the three-dimensional sound field in the opposite direction to the movement of user 99.

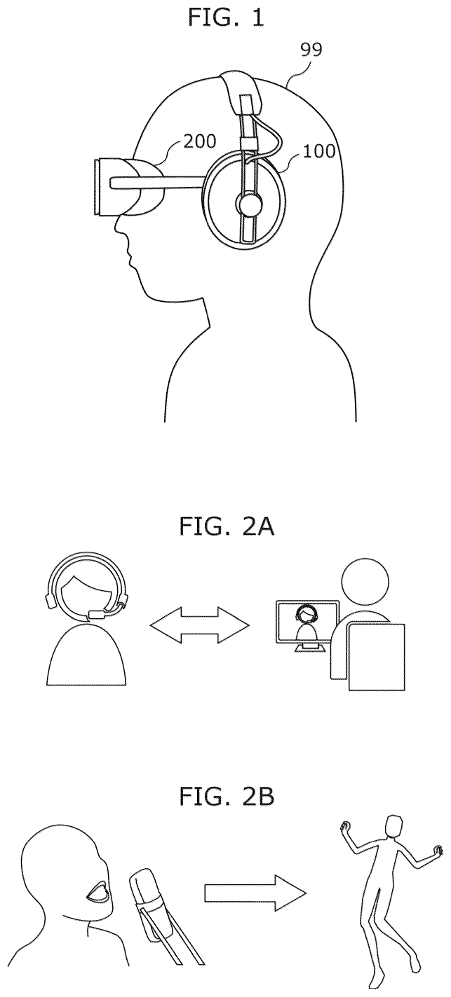

Here, for the purpose of enhancing the sense of realism of the sound heard by user 99, acoustic processing may be executed to impart fluctuation to the sound. For example, FIG. 2A and FIG. 2B are diagrams for explaining a usage example of an acoustic reproduction system according to an embodiment. FIG. 2A illustrates a user engaged in a video call. In the left diagram of FIG. 2A, the sound is collected under conditions where the relative position between the mouth (sound source) and the microphone of the headset (sound collection device) hardly change, as with a headset. In contrast, in the right diagram, at the call destination, a sense of incongruity arises due to the fact that the position between the sound source and the sound collection device hardly moves with respect to the user moving in the video. In such a case, by applying sound fluctuations according to the movement of the user moving in the video, or sound fluctuations according to the general movement of the user during a conversation, the sense of incongruity regarding the sound is reduced and the sense of realism is increased.

FIG. 2B illustrates a user collecting the sound of a song for a so-called virtual concert in a studio. The user collecting the sound may be a different user from the listener, i.e., user 99. For example, singers or artists are envisioned. In the left diagram of FIG. 2B, the sound of the song is collected as the user sings toward a fixed microphone. The collected sound is used to play audio in the virtual image shown in the right diagram, and a virtual concert is realized by viewing it together with an image of an avatar modeled after the user dancing and singing in a concert venue within the virtual space, thereby achieving a virtual concert performance. Here, when specifying the position of the sound source object (avatar's head) in the virtual sound space as the audio playback position following the avatar's movement, even if the position matches, subtle variations in the fluctuations that should be in the user's actual voice are not reproduced, and the sense of realism of the sound decreases. In the present disclosure, acoustic processing is performed to increase the sense of realism of sound by imparting fluctuations that should originally exist to the audio. As another situation where a similar issue arises, even when using a sound collection device capable of collecting sound including fluctuations in the user's voice in a video call as illustrated in FIG. 2A, mechanical voice processing such as automatic gain control (AGC) may be applied to make the sound easier for listeners to hear, inhibiting fluctuations in the voice and conversely causing a sense of incongruity. The present disclosure also includes reducing the sense of incongruity and increasing the sense of realism regarding the sound by re-imparting fluctuations that have been inhibited by such mechanical voice processing.

However, the imparting of fluctuations is performed by applying filter processing to the sound signal to be output, so as to repeatedly shift the sound in the time domain. This process is complicated because it requires applying different filters at two consecutive time points in the time domain, and it is desirable not to apply acoustic processing under conditions where the fluctuation effect is not expected.

### Structure

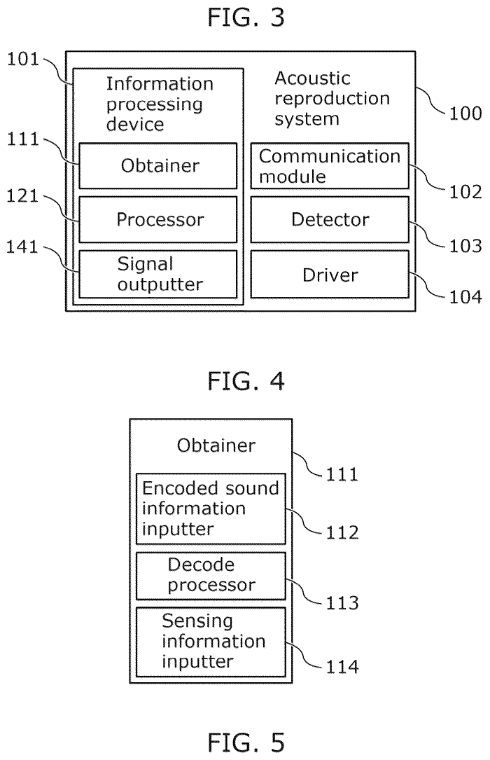

Next, a configuration of acoustic reproduction system 100 according to the present embodiment will be described with reference to FIG. 3. FIG. 3 is a block diagram illustrating the functional configuration of an acoustic reproduction system according to an embodiment.

As illustrated in FIG. 3, acoustic reproduction system 100 according to the present embodiment includes information processing device 101, communication module 102, detector 103, and driver 104.

Information processing device 101 is one example of an acoustic processing device, and is a computing device for executing various types of signal processing in acoustic reproduction system 100. Information processing device 101 includes a processor and memory, such as in a computer, and is implemented by the processor executing a program stored in the memory. The functions related to each functional element described below are realized by executing this program.

Information processing device 101 includes obtainer 111, processor 121, and signal outputter 141. Each functional element included in information processing device 101 will be described in detail below along with details regarding configurations other than information processing device 101.

Communication module 102 is an interface device for receiving input of sound information to acoustic reproduction system 100. For example, communication module 102 includes an antenna and a signal converter, and receives sound information from an external device via wireless communication. More specifically, communication module 102 receives, via the antenna, a wireless signal indicating sound information converted into a format for wireless communication, and reconverts the wireless signal into sound information using the signal converter. In this way, acoustic reproduction system 100 obtains sound information from the external device via wireless communication. Sound information obtained by communication module 102 is obtained by obtainer 111. In this way, the sound information is input to information processing device 101. Communication between acoustic reproduction system 100 and the external device may be wired communication.

The sound information obtained by acoustic reproduction system 100 is an audio signal generated by collecting sound emitted from a sound source using a sound collection device. The sound information is, for example, encoded in a predetermined format such as MPEG-H 3D Audio (ISO/IEC 23008-3), MPEG-I, etc. As one example, encoded sound information includes information about a predetermined sound that is reproduced by acoustic reproduction system 100, information about a localization position when the sound image of the sound is localized at a predetermined position in a three-dimensional sound field (i.e., the sound is perceived as arriving from a predetermined direction), and other metadata. For example, the sound information includes information related to a plurality of sounds including a first predetermined sound and a second predetermined sound, and the sound images are localized so that when each sound is reproduced, the sound images are perceived as sounds arriving from different positions in a three-dimensional sound field.

This three-dimensional sound, for example, combined with images visually recognized using stereoscopic image reproduction device 200, can enhance the sense of realism of viewed and listened content. Note that the sound information may include only information about the predetermined sound. In such cases, information related to the predetermined position may be separately obtained. As described above, the sound information includes first sound information related to the first predetermined sound and second sound information related to the second predetermined sound, but a plurality of items of sound information separately including these may be obtained respectively and simultaneously reproduced to localize sound images at different positions in the three-dimensional sound field. Thus, the form of the input sound information is not particularly limited, and acoustic reproduction system 100 may include obtainer 111 corresponding to various forms of sound information.

The metadata included in the sound information includes control information for controlling acoustic processing to impart fluctuation. The control information is information for indicating whether to execute the acoustic processing. For example, when the control information indicates to execute acoustic processing, the system may further determine whether a predetermined condition is satisfied and execute the acoustic processing if the predetermined condition is satisfied, or may execute the acoustic processing regardless of whether the predetermined condition is satisfied. When the control information indicates not to execute acoustic processing, the acoustic processing is skipped. Thus, the acoustic processing may be executed based on two triggers: determining whether a predetermined condition is satisfied and whether the control information indicates to execute acoustic processing, or the acoustic processing may be executed based on one trigger: whether the control information indicates to execute acoustic processing. The control information need not be included in the metadata. For example, the control information can be specified by operation settings of acoustic reproduction system 100, and may be stored in storage. The control information may be obtained at startup of acoustic reproduction system 100 and used as described above.

The metadata may also include sound collection situation information. The sound collection situation information is a reverberation level and a noise level related to the collection of predetermined sound included in the sound information. The sound collection situation information will be described in greater detail later.

The sound information may be obtained as a bitstream. An example of the bitstream structure when obtaining the sound information as a bitstream will be described. The bitstream includes, for example, an audio signal and metadata. The audio signal is sound data that expresses sound, indicating information such as the frequency and intensity of the sound. The metadata may include spatial information other than the aforementioned information. The spatial information is information about a space in which a listener who listens to sound based on the audio signal is located. More specifically, the spatial information is information about the predetermined position (localization position) when localizing the sound image of the sound at a predetermined position in the sound space (for example, within a three-dimensional sound field), that is, when causing the listener to perceive the sound as arriving from a predetermined direction. The spatial information includes, for example, sound source object information, and position information indicating the position of the listener.

The sound source object information is information about an object that generates sound based on the audio signal, i.e., reproduces the audio signal, and is information about a virtual object (sound source object) placed in a sound space, which is a virtual space corresponding to the real space in which the object is placed. The sound source object information includes, for example, information indicating the position of the sound source object located in the sound space, information about the orientation of the sound source object, information about the directivity of the sound emitted by the sound source object, information indicating whether the sound source object belongs to an animate thing, and information indicating whether the sound source object is a mobile body. For example, the audio signal corresponds to one or more sound source objects indicated by the sound source object information.

As one example of the data structure of the bitstream, the bitstream includes, for example, metadata (control information) and an audio signal.

The audio signal and metadata may be stored in a single bitstream or may be separately stored in a plurality of bitstreams. Similarly, the audio signal and metadata may be stored in a single file or may be separately stored in a plurality of files.

There may be a bitstream for each sound source or for each playback time. When bitstreams exist for each playback time, a plurality of bitstreams may be processed in parallel simultaneously.

Metadata may be given for each bitstream, or may be given collectively as information for controlling a plurality of bitstreams. The metadata may also be given for each playback time.

When the audio signal and metadata are stored separately in a plurality of bitstreams or a plurality of files, information indicating another bitstream or file relevant to one or some of the bitstreams or files may be included, or information indicating another bitstream or file relevant to each of all the bitstreams or files may be included. Here, a relevant bitstream or file is, for example, a bitstream or file that may be simultaneously used in acoustic processing. A relevant bitstream or file may include a bitstream or file that collectively describes information indicating other related bitstreams or files.

Examples of the information indicating other relevant bitstreams or files are identifiers indicating the other bitstreams, or filenames, URLs (Uniform Resource Locator), or URIs (Uniform Resource Identifier) indicating the other files. In this case, obtainer 111 identifies or obtains a bitstream or a file, based on information indicating a relevant other bitstream or a relevant other file. The bitstream may include not only information indicating another bitstream relevant to the bitstream but also information indicating a bitstream or file relevant to another bitstream or file. The file including information indicating the relevant bitstream or file may be, for example, a control file such as a manifest file used for content distribution.

Note that entire metadata or part of metadata may be obtained from somewhere other than a bitstream that includes an audio signal. For example, metadata for controlling an acoustic sound or metadata for controlling a video may be obtained from somewhere other than from a bitstream or both may be obtained from somewhere other than from a bitstream. When metadata for controlling video is included in the bitstream obtained by the audio signal reproduction system (corresponding to acoustic reproduction system 100), the audio signal reproduction system may include a function to output metadata that can be used for controlling video to a display device that displays images, or to a stereoscopic image reproduction device (for example, stereoscopic image reproduction device 200 in the embodiment) that reproduces stereoscopic images.

Next, examples of information included in the metadata will be described.

The metadata may be information used for describing a scene expressed in the sound space. Here, the term “scene” refers to an aggregate of all elements representing three-dimensional images and acoustic events in the sound space, which are modeled in the audio signal reproduction system using metadata. Thus, metadata herein may include not only information for controlling acoustic processing, but also information for controlling video processing. The metadata may of course include information for controlling only acoustic processing or video processing, or may include information for use in controlling both.

The audio signal reproduction system generates virtual acoustic effects by performing acoustic processing on the audio signal using metadata included in the bitstream and additionally obtained interactive listener position information. In the present embodiment, a case where early reflection processing, obstacle processing, diffraction processing, occlusion processing, and reverberation processing are performed among acoustic effects is explained, but other acoustic processing may be performed using metadata. For example, the audio signal reproduction system may add acoustic effects such as distance attenuation effect, localization, and Doppler effect. Information for switching on or off all or part of the acoustic effects, and priority information may be added as metadata.

As an example, encoded metadata includes information about a sound space including a sound source object and an obstacle object and information about a localization position when the sound image of the sound is localized at a predetermined position in the sound space (i.e., the sound is perceived as arriving from a predetermined direction). Here, an obstacle object is an object that can affect the sound perceived by the listener, for example, by blocking or reflecting the sound, during the period until the sound emitted by the sound source object reaches the listener. Obstacle objects can include not only stationary objects but also animals such as humans or mobile bodies such as machines. When there are a plurality of sound source objects in the sound space, for any given sound source object, the other sound source objects can become obstacle objects. Non-sound-emitting objects such as building material and inanimate objects, as well as sound source objects that emit sound, can both become obstacle objects.

The metadata includes all or some of the information representing the shape of the sound space, geometry information and position information of obstacle objects in the sound space, geometry information and position information of sound source objects in the sound space, and the position and orientation of the listener in the sound space.

The sound space may be either a closed space or an open space. The metadata also includes information representing the reflectivity of structures that can reflect sound in the sound space, such as floors, walls, or ceilings, and the reflectivity of obstacle objects present in the sound space. As used herein, reflectance is the ratio of energy of reflected sound to incident sound, and is set for each frequency band of the sound. The reflectance may be set uniformly regardless of the frequency band of the sound. If the sound space is an open space, parameters such as a uniformly set attenuation rate, diffracted sound, early reflected sound, and the like may be used.

In the above description, reflectance is given as an example, but the metadata may include information other than reflectance as a parameter with regard to an obstacle object or a sound source object included in the metadata. For example, information other than reflectance may include information on the material of an object as metadata related to both of a sound source object and a non-sound-emitting object. More specifically, information other than reflectance may include parameters such as a diffusion factor, a transmittance, or an acoustic absorptivity.

Information related to the sound source object may include loudness, radiation characteristics (directivity), reproduction conditions, the number and types of sound sources emitted from a single object, and information specifying the sound source region in the object. The reproduction condition may determine that a sound is, for example, a sound that is continuously being emitted or is emitted at an event. The sound source region in the object may be determined based on the relative relationship between the position of the listener and the position of the object, or may be determined with reference to the object. When the sound source region in the object is determined based on the relative relationship between the position of the listener and the position of the object, with respect to the plane along which the listener is looking at the object, the listener can be made to perceive that sound A is emitted from the right side of the object and sound B is emitted from the left side of the object as seen from the listener. When the sound source region in the object is determined with reference to the object, regardless of the direction in which the listener is looking, it is possible to fixate which sound is emitted from which region of the object. For example, the listener can be made to perceive that a high-pitched sound is emitted from the right side and a low-pitched sound is emitted from the left side when viewing the object from the front. In this case, when the listener moves around to the back of the object, the listener can be made to perceive that a low-pitched sound is emitted from the right side and a high-pitched sound is emitted from the left side as seen from the back.

The time until an initial reflected sound arrives, the reverberation time, and the ratio between the direct sound and the diffused sound, for instance, can be included as metadata related to a space. When the ratio between the direct sound and the diffused sound is zero, the listener can be made to perceive only the direct sound.

One example of obtainer 111 will be described with reference to FIG. 4. FIG. 4 is a block diagram illustrating the functional configuration of an obtainer according to an embodiment. As illustrated in FIG. 4, obtainer 111 according to the present embodiment includes, for example, encoded sound information inputter 112, decode processor 113, and sensing information inputter 114.

Encoded sound information inputter 112 is a processor into which encoded sound information obtained by obtainer 111 is input. Encoded sound information inputter 112 outputs the input sound information to decode processor 113.

Decode processor 113 is a processor that generates information related to predetermined sound included in the sound information and information related to a predetermined position in a format to be used in subsequent processing by decoding the sound information output from encoded sound information inputter 112.

Sensing information inputter 114 will be described below along with the function of detector 103.

Detector 103 is for detecting the movement speed of the head of user 99. Detector 103 includes a combination of various sensors used for detecting movement, such as a gyro sensor and an acceleration sensor. In the present embodiment, detector 103 provided in acoustic reproduction system 100, but it may be provided in an external device, such as stereoscopic image reproduction device 200 that operates in response to the movement of the head of user 99, similarly to acoustic reproduction system 100. In such cases, detector 103 need not be included in acoustic reproduction system 100. Detector 103 may be an external imaging device or the like that captures images of the movement of the head of user 99, and the movement of user 99 may be detected by processing the captured images.

Detector 103 is, for example, integrally fixed to the housing of acoustic reproduction system 100, and detects the movement speed of the housing. Acoustic reproduction system 100 including the above-mentioned housing, after being worn by user 99, moves integrally with the head of user 99, and therefore detector 103 can detect the movement speed of the head of user 99.

Detector 103 may, for example, detect a rotation amount with at least one of three mutually orthogonal axes in three-dimensional space as a rotation axis, or detect a displacement amount with at least one of the three axes as a displacement direction, as an amount of movement of the head of user 99. Detector 103 may also detect both the rotation amount and the displacement amount as the amount of movement of the head of user 99.

Sensing information inputter 114 obtains the movement speed of the head of user 99 from detector 103. More specifically, sensing information inputter 114 obtains, as the movement speed, the amount of movement of the head of user 99 detected by detector 103 per unit time. In this way, sensing information inputter 114 obtains at least one of the rotation speed or the displacement speed from detector 103. Here, the amount of movement of the head of user 99 that is obtained is used to determine the position and posture (in other words, the coordinates and orientation) of user 99 in the three-dimensional sound field. In acoustic reproduction system 100, sound is reproduced by determining the relative position of the sound image based on the determined coordinates and orientation of user 99. Therefore, the listening point in the three-dimensional sound field can be changed according to the amount of movement of the head of user 99. Stated differently, sensing information inputter 114 can receive an instruction to change the relative position between the listening point and the sound image (sound source object), including a first amount of change by which the relative position changes according to the instruction. Note that the relative position is a concept indicating one position relative to another, expressed by at least one of the relative distance and relative direction between the sound collection device or listening point and the sound image (sound source object).

Processor 121 determines, based on the determined coordinates and orientation of user 99, from which direction in the three-dimensional sound field to cause user 99 to perceive a predetermined sound as arriving, based on the coordinates and orientation of user 99, and processes the sound information such that the output sound information to be reproduced becomes such a sound. Processor 121 executes acoustic processing to impart fluctuation, along with the above-described processing. Here, the fluctuation imparted includes fluctuation in relative distance that repeatedly changes in the time domain between the sound source object and the sound collection device, and fluctuation in relative direction that repeatedly changes in the time domain between the sound source object and the sound collection device.

FIG. 5 is a block diagram illustrating the functional configuration of a processor according to an embodiment. As illustrated in FIG. 5, processor 121 includes determiner 122, storage 123, and executor 124 as functional elements for executing acoustic processing. Note that processor 121 also includes other, non-illustrated functional elements as functional elements related to the processing of the above-described sound information.

Determiner 122 makes a determination for deciding whether to execute the acoustic processing. For example, determiner 122 determines whether to execute the acoustic processing by determining whether a predetermined condition is satisfied, determines to execute the acoustic processing if the predetermined condition is satisfied, and determines to skip the acoustic processing if the predetermined condition is not satisfied. The predetermined condition will be described in greater detail later. Information indicating the predetermined condition is, for example, stored in a storage device by storage 123.

Storage 123 is a storage controller that performs processing to store information in a storage device (not illustrated) that stores information, and to read out information.

Executor 124 executes acoustic processing in accordance with the determination result of determiner 122.

Signal outputter 141 is a functional element that generates an output sound signal and outputs the generated output sound signal to driver 104.

Signal outputter 141 determines the localization position of sound, and along with processing to localize it at that position, generates an output audio signal as digital data for the sound information after acoustic processing has been executed in accordance with the determination result. Signal outputter 141 generates a waveform signal by performing digital-to-analog signal conversion based on the output audio signal, causes driver 104 to generate sound waves based on the waveform signal, and presents sound to user 99. Driver 104 includes, for example, a diaphragm and a driving mechanism such as a magnet and a voice coil. Driver 104 operates the driving mechanism in accordance with the waveform signal, and causes the diaphragm to vibrate via the driving mechanism. In this way, driver 104 generates sound waves by vibrating the diaphragm in accordance with the output audio signal (meaning to “reproduce” the output sound signal, that is, user 99 perceiving it is not included in the meaning of “reproduction”), the sound waves propagate through the air and are transmitted to user 99's ears, and user 99 perceives the sound.

### Other Examples of Acoustic Reproduction System According to Present Embodiment

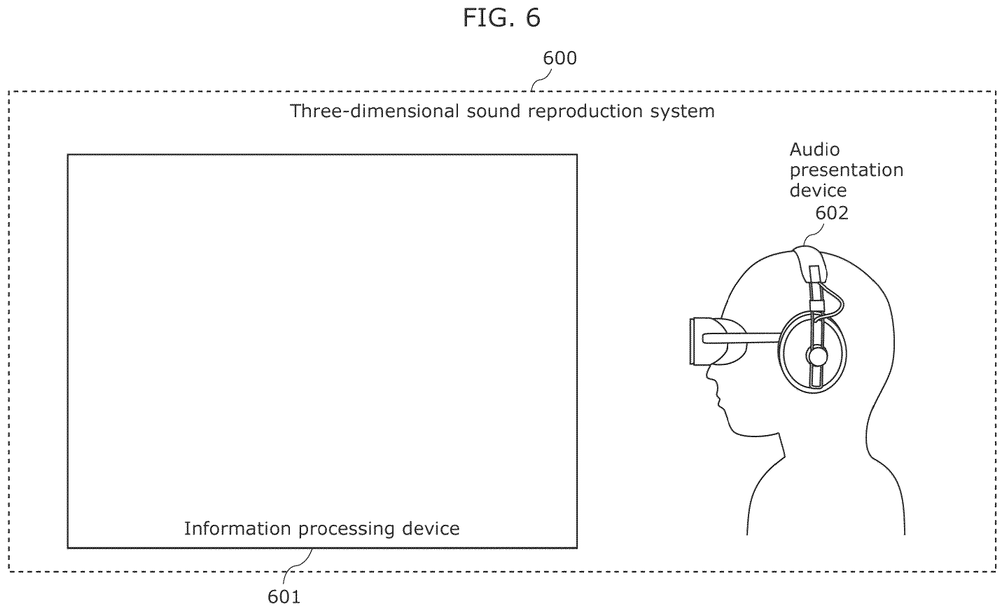

In the above example, while it has been described that acoustic reproduction system 100 according to the present embodiment is an audio presentation device and includes information processing device 101, communication module 102, detector 103, and driver 104, the functions of acoustic reproduction system 100 may be implemented by a plurality of devices or may be implemented by a single device. This will be described with reference to FIG. 6 through FIG. 15. FIG. 6 through FIG. 15 are diagrams for explaining another example of an acoustic reproduction system according to an embodiment.

For example, information processing device 601 may be included in audio presentation device 602, and audio presentation device 602 may perform both acoustic processing and sound presentation. The acoustic processing described in the present disclosure may be divided between information processing device 601 and audio presentation device 602 and performed, or a server connected via a network to information processing device 601 or audio presentation device 602 may perform part or all of the acoustic processing described in the present disclosure.

Although the naming “information processing device” 601 is used in the above description, when information processing device 601 performs acoustic processing by decoding a bitstream generated by encoding at least a portion of data of an audio signal or spatial information used for acoustic processing, information processing device 601 may be called a decoding device, or acoustic reproduction system 100 (i.e., three-dimensional sound reproduction system 600 in the figures) may be called a decoding processing system.

Here, an example in which acoustic reproduction system 100 functions as a decoding processing system will be described.

### Encoding Device Example

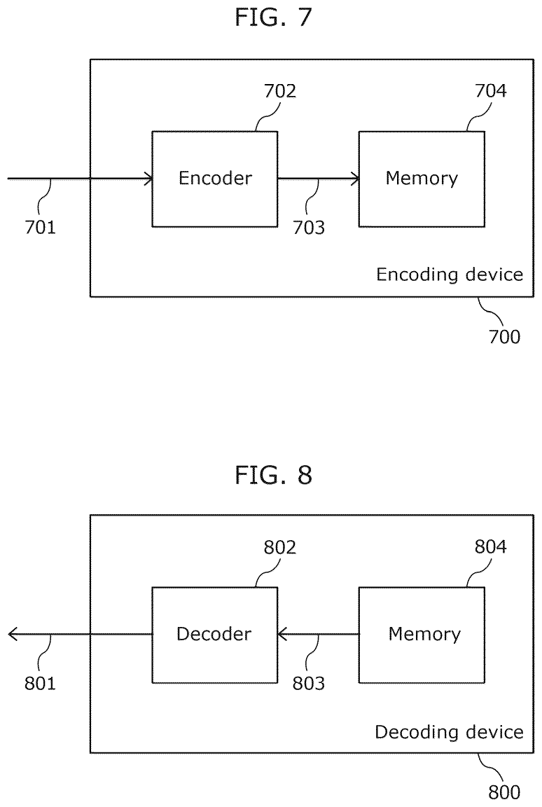

FIG. 7 is a functional block diagram illustrating the configuration of encoding device 700, which is one example of an encoding device of the present disclosure.

Input data 701 is data to be encoded that includes spatial information and/or an audio signal to be input to encoder 702. The spatial information will be described in greater detail later.

Encoder 702 encodes input data 701 to generate encoded data 703. Encoded data 703 is, for example, a bitstream generated by the encoding process.

Memory 704 stores encoded data 703. Memory 704 may be, for example, a hard disk or a solid-state drive (SSD), or may be any other type of memory device.

Although a bitstream generated by the encoding process was given as one example of encoded data 703 stored in memory 704 in the above description, encoded data 703 may be data other than a bitstream. For example, encoding device 700 may store, in memory 704, converted data generated by converting the bitstream into a predetermined data format. The data after conversion may be, for example, a file storing one or a plurality of bitstreams or a multiplexed stream. Here, the file is, for example, a file having a file format such as ISOBMFF (ISO Base Media File Format). Encoded data 703 may be in the form of a plurality of packets generated by dividing the above-mentioned bitstream or file. When the bitstream generated by encoder 702 is to be converted into data different from the bitstream, encoding device 700 may include a converter not shown in the figure, or may perform the conversion process using a central processing unit (CPU).

### Decoding Device Example

FIG. 8 is a functional block diagram illustrating the configuration of decoding device 800, which is one example of a decoding device of the present disclosure.

Memory 804 stores, for example, the same data as encoded data 703 generated by encoding device 700. Memory 804 reads the stored data and inputs it as input data 803 to decoder 802. Input data 803 is, for example, a bitstream to be decoded. Memory 804 may be, for example, a hard disk or an SSD, or may be any other type of memory device.

Decoding device 800 may use, as input data 803, converted data generated by converting the data read from memory 804, rather than directly using the data stored in memory 804 as input data 803. The data before conversion may be, for example, multiplexed data storing one or a plurality of bitstreams. Here, the multiplexed data may be, for example, a file having a file format such as ISOBMFF. Pre-conversion data may be in the form of a plurality of packets generated by dividing the above-mentioned bitstream or file. When converting data different from the bitstream read from memory 804 into a bitstream, decoding device 800 may include a converter not shown in the figure, or may perform the conversion process using a CPU.

Decoder 802 decodes input data 803 to generate audio signal 801 to be presented to a listener.

### Another Example of Encoding Device

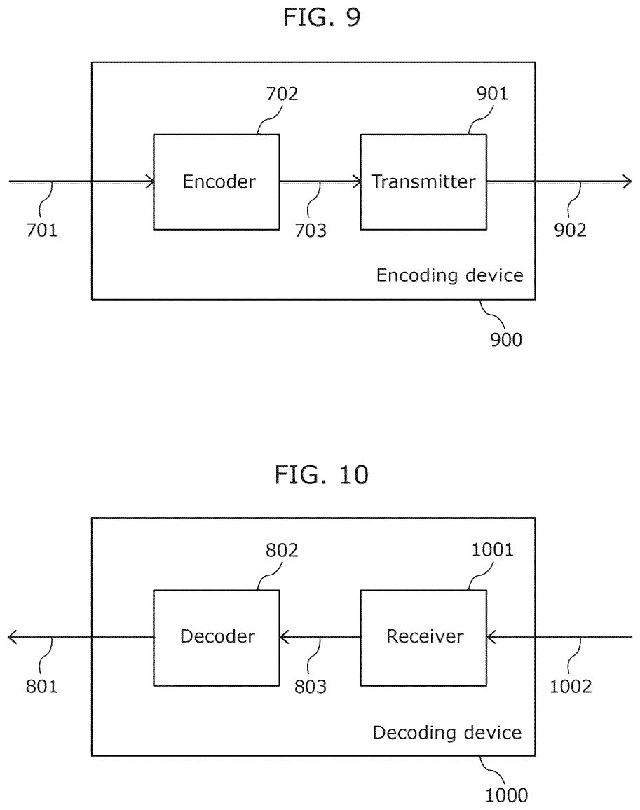

FIG. 9 is a functional block diagram illustrating the configuration of encoding device 900, which is another example of an encoding device of the present disclosure. In FIG. 9, the same reference numerals are assigned to configurations having the same functions as those in FIG. 7, and repeated explanation of these configurations will be omitted.

Encoding device 900 differs from encoding device 700 in that while encoding device 700 includes memory 704 that stores encoded data 703, encoding device 900 includes transmitter 901 that transmits encoded data 703 to an external destination.

Transmitter 901 transmits transmission signal 902 to another device or server based on encoded data 703 or data in another data format generated by converting encoded data 703. The data used for generating transmission signal 902 is, for example, the bitstream, multiplexed data, file, or packet explained in regard to encoding device 700.

### Another Example of Decoding Device

FIG. 10 is a functional block diagram illustrating the configuration of decoding device 1000, which is another example of a decoding device of the present disclosure. In FIG. 10, the same reference numerals are assigned to configurations having the same functions as those in FIG. 8, and repeated explanation of these configurations will be omitted.

Decoding device 1000 differs from decoding device 800 in that while decoding device 800 reads input data 803 from memory 804, decoding device 1000 includes receiver 1001 that receives input data 803 from an external source.

Receiver 1001 receives reception signal 1002 thereby obtaining reception data, and outputs input data 803 to be input to decoder 802. The reception data may be the same as input data 803 input to decoder 802, or may be data in a data format different from input data 803. When the reception data is data in a data format different from input data 803, receiver 1001 may convert the reception data to input data 803, or a converter not shown in the figure or a CPU included in decoding device 1000 may convert the reception data to input data 803. The reception data is, for example, the bitstream, multiplexed data, file, or packet explained in regard to encoding device 900.

### Explanation of Functions of Decoder

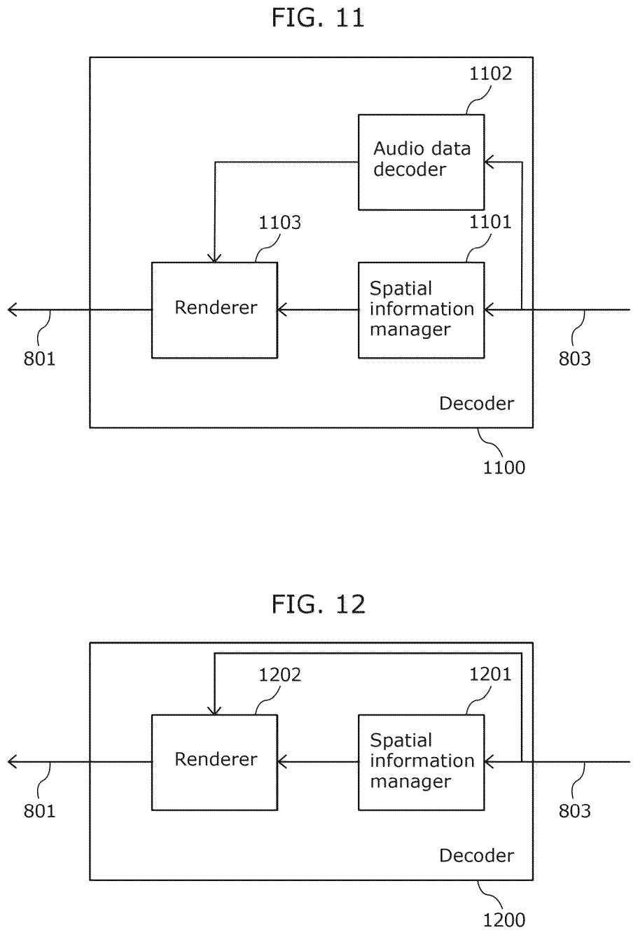

FIG. 11 is a functional block diagram illustrating the configuration of decoder 1100, which is one example of decoder 802 in FIG. 8 or FIG. 10.

Input data 803 is an encoded bitstream and includes encoded audio data, which is an encoded audio signal, and metadata used for acoustic processing.

Spatial information manager 1101 obtains metadata included in input data 803, and analyzes the metadata. The metadata includes information describing elements placed in the sound space that act on sounds. Spatial information manager 1101 manages spatial information necessary for acoustic processing obtained by analyzing the metadata, and provides the spatial information to renderer 1103. Note that in the present disclosure, the information used for acoustic processing is referred to as spatial information, but this information may be referred to be some other name. The information used for this acoustic processing may be referred to as, for example, sound space information or scene information. When the information used for acoustic processing changes over time, the spatial information input to renderer 1103 may be referred to as a spatial state, a sound space state, a scene state, or the like.

The spatial information may be managed per sound space or per scene. For example, when expressing different rooms as virtual spaces, each room may be managed as a scene of a different sound space, or even for the same space, the spatial information may be managed as different scenes depending on the scene being expressed. In the management of spatial information, an identifier for identifying each item of spatial information may be assigned. The spatial information data may be included in a bitstream, which is one form of input data 803, or the bitstream may include an identifier of the spatial information, and the spatial information data may be obtained from somewhere other than the bitstream. When the bitstream includes only the identifier of the spatial information, at the time of rendering, the spatial information data stored in the memory of the acoustic signal processing device or in an external server may be obtained as input data using the identifier of the spatial information.

Note that the information managed by spatial information manager 1101 is not limited to information included in the bitstream. For example, input data 803 may include data indicating characteristics or structure of a space obtained from a VR or AR software application or server as data not included in the bitstream. For example, input data 803 may include data indicating characteristics or a position of a listener or object as data not included in the bitstream. Input data 803 may include information obtained by a sensor included in a terminal that includes the decoding device as information indicating the position of the listener, or information indicating the position of the terminal estimated based on information obtained by the sensor. That is, spatial information manager 1101 may communicate with an external system or server and obtain spatial information and the position of the listener. Spatial information manager 1101 may obtain clock synchronization information from an external system and execute a process to synchronize with the clock of renderer 1103. The space in the above explanation may be a virtually formed space, that is, a VR space, or it may be a real space or a virtual space corresponding to a real space, that is, an AR space or a mixed reality (MR) space. The virtual space may be called a sound field or sound space. The information indicating position in the above description may be information such as coordinate values indicating a position in space, or may be information indicating a relative position with respect to a predetermined reference position, or may be information indicating movement or acceleration of a position in space.

Audio data decoder 1102 decodes encoded audio data included in input data 803 to obtain an audio signal.

The encoded audio data obtained by three-dimensional sound reproduction system 600 is, for example, a bitstream encoded in a predetermined format such as MPEG-H 3D Audio (ISO/IEC 23008-3). MPEG-H 3D Audio is merely one example of an encoding method that can be used when generating encoded audio data included in the bitstream, and the bitstream may include encoded audio data encoded using other encoding methods. For example, the encoding method used may be a lossy codec such as MP3 (MPEG-1 Audio Layer-3), AAC (Advanced Audio Coding), WMA (Windows Media Audio), AC3 (Audio Codec-3), or Vorbis, or may be a lossless codec such as ALAC (Apple Lossless Audio Codec) or FLAC (Free Lossless Audio Codec), or any other encoding method other than those mentioned above may be used. For example, PCM (Pulse Code Modulation) data may be one type of encoded audio data. In such cases, the decoding process may, for example, when the number of quantization bits of PCM data is N, convert the N-bit binary number into a numerical format (for example, floating-point format) that can be processed by renderer 1103.

Renderer 1103 receives an audio signal and spatial information as inputs, applies acoustic processing to the audio signal using the spatial information, and outputs acoustic-processed audio signal 801.

Before starting rendering, spatial information manager 1101 reads metadata of the input signal, detects rendering items such as objects or sounds specified by the spatial information, and transmits the detected rendering items to renderer 1103. After rendering starts, spatial information manager 1101 obtains the temporal changes in the spatial information and the listener's position, and updates and manages the spatial information. Spatial information manager 1101 then transmits the updated spatial information to renderer 1103. Renderer 1103 generates and outputs an audio signal with acoustic processing added based on the audio signal included in the input data and the spatial information received from spatial information manager 1101.

The update processing of the spatial information and the output processing of the audio signal added with acoustic processing may be executed in the same thread, or spatial information manager 1101 and renderer 1103 may be allocated to respective independent threads. The update processing of the spatial information and the output processing of the audio signal added with acoustic processing may be processed in different threads, and the activation frequency of the threads may be set individually, or the processing may be executed in parallel.

By executing processing in different independent threads for spatial information manager 1101 and renderer 1103, computational resources can be preferentially allocated to renderer 1103, allowing for safe implementation even in cases of sound output processing where even slight delays cannot be tolerated, for example, sound output processing where a popping noise occurs if there is a delay of even one sample (0.02 msec). In this case, allocation of computational resources to spatial information manager 1101 is restricted. However, the update of the spatial information is a low-frequency process (for example, a process such as updating the direction of the listener's face) compared to the output processing of the audio signal. Therefore, since it is not necessarily required to respond instantaneously like the output processing of the audio signal, even if allocation of computational resources is restricted, there is no significant impact on the acoustic quality provided to the listener.

The update of the spatial information may be executed periodically at predetermined times or intervals, or may be executed when a predetermined condition is met. The update of the spatial information may be executed manually by the listener or the manager of the sound space, or may be triggered by changes in an external system. For example, when the listener operates a controller to instantly warp the position of their avatar, rapidly advance or rewind time, or when the manager of the virtual space suddenly changes the environment of the scene as a production effect, the thread in which spatial information manager 1101 is arranged may be activated as a one-time interrupt process in addition to periodic activation.

The role of the information update thread that executes the update processing of the spatial information is, for example, processing to update the position or orientation of the listener's avatar placed in the virtual space based on the position or orientation of the VR goggles worn by the listener, and updating the position of objects moving within the virtual space, and is handled within a processing thread that activates at a relatively low frequency of approximately several tens of Hz. Such processing that reflects the characteristics of direct sound may be performed in a processing thread with a low occurrence frequency. This is because the frequency at which the characteristics of direct sound change is lower than the frequency of occurrence of audio processing frames for audio output. Rather, by doing so, the computational load of this processing can be relatively reduced, and the risk of pulsive noise occurring due to unnecessarily frequent information updates can be avoided.

FIG. 12 is a functional block diagram illustrating the configuration of decoder 1200, which is another example of decoder 802 in FIG. 8 or FIG. 10.

FIG. 12 differs from FIG. 11 in that input data 803 includes an unencoded audio signal rather than encoded audio data. Input data 803 includes an audio signal and a bitstream including metadata.

Spatial information manager 1201 is the same as spatial information manager 1101 in FIG. 11, so repeated explanation is omitted.

Renderer 1202 is the same as renderer 1103 in FIG. 11, so repeated explanation is omitted.

Note that while the configuration in FIG. 12 is referred to as a decoder in the above description, it may also be called an acoustic processor that performs acoustic processing. Moreover, a device including the acoustic processor may be called an acoustic processing device rather than a decoding device. Acoustic signal processing device (information processing device 601) may be called an acoustic processing device.

### Physical Configuration of Encoding Device

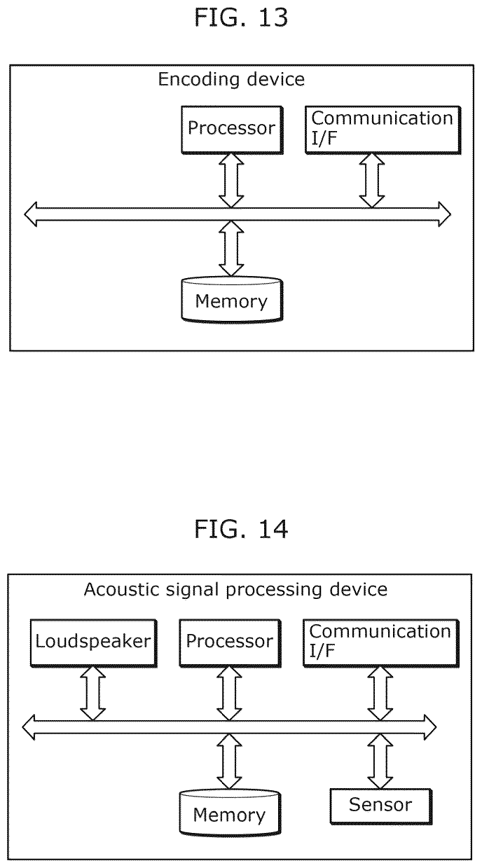

FIG. 13 illustrates one example of a physical configuration of the encoding device. The encoding device illustrated in FIG. 13 is one example of the above-mentioned encoding devices 700 and 900.

The encoding device of FIG. 13 includes a processor, memory, and a communication I/F.

The processor is, for example, a central processing unit (CPU) or digital signal processor (DSP) or graphics processing unit (GPU), and the encoding processing according to the present disclosure may be performed by the CPU or DSP or GPU executing a program stored in the memory. The processor may also be a dedicated circuit that performs signal processing on an audio signal including the encoding processing according to the present disclosure.

The memory includes, for example, random access memory (RAM) or read only memory (ROM). The memory may include magnetic storage media such as a hard disk, or semiconductor memory such as a solid-state drive (SSD). Moreover, the term “memory” may include internal memory incorporated in a CPU or GPU.

The communication I/F (interface) is, for example, a communication module corresponding to communication methods such as Bluetooth (registered trademark) or WiGig (registered trademark). The encoding device includes a function to communicate with other communication devices via the communication I/F, and transmits an encoded bitstream.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

### Physical Configuration of Acoustic Signal Processing Device

FIG. 14 illustrates one example of a physical configuration of the acoustic signal processing device. Note that the acoustic signal processing device in FIG. 14 may be a decoding device. A portion of the configuration described here may be included in audio presentation device 602. The acoustic signal processing device illustrated in FIG. 14 is one example of the above-mentioned acoustic signal processing device 601.

The acoustic signal processing device of FIG. 14 includes a processor, memory, a communication I/F, a sensor, and a loudspeaker.

The processor is, for example, a central processing unit (CPU) or digital signal processor (DSP) or graphics processing unit (GPU), and the acoustic processing or decoding processing according to the present disclosure may be performed by the CPU or DSP or GPU executing a program stored in the memory. The processor may also be a dedicated circuit that performs signal processing on an audio signal including the acoustic processing according to the present disclosure.

The memory includes, for example, random access memory (RAM) or read only memory (ROM). The memory may include magnetic storage media such as a hard disk, or semiconductor memory such as a solid-state drive (SSD). The term “memory” may include internal memory incorporated in a CPU or GPU.

The communication I/F (interface) is, for example, a communication module corresponding to communication methods such as Bluetooth (registered trademark) or WiGig (registered trademark). The acoustic signal processing device illustrated in FIG. 2I includes a function to communicate with other communication devices via the communication I/F, and obtains a bitstream to be decoded. The obtained bitstream is, for example, stored in memory.

The communication module includes, for example, a signal processing circuit and an antenna that correspond to the communication method. In the above example, Bluetooth (registered trademark) or WiGig (registered trademark) were cited as examples of communication methods, but the communication method may support Long Term Evolution (LTE), New Radio (NR), or Wi-Fi (registered trademark). Moreover, the communication I/F may be a wired communication method such as Ethernet (registered trademark), Universal Serial Bus (USB), or High-Definition Multimedia Interface (HDMI) (registered trademark), rather than the wireless communication methods described above.

The sensor performs sensing to estimate the position or orientation of the listener. More specifically, the sensor estimates the position and/or orientation of the listener based on one or a plurality of detection results of the position, orientation, movement, velocity, angular velocity, or acceleration of a part or all of the listener's body, such as the listener's head, and generates position information indicating the position and/or orientation of the listener. The position information may be information indicating the position and/or orientation of the listener in real space, or may be information indicating the displacement of the position and/or orientation of the listener with respect to the position and/or orientation of the listener at a predetermined time point. The position information may be information indicating the position and/or orientation relative to the three-dimensional sound reproduction system or an external device including a sensor.

The sensor may be, for example, an imaging device such as a camera or a distance measuring device such as Light Detection And Ranging (LIDAR), and may capture images of the movement of the head of the listener, and detect the movement of the head of the listener by processing the captured images. As the sensor, a device that performs position estimation using wireless communication in any frequency band, such as millimeter waves, may be used.

Note that the acoustic signal processing device illustrated in FIG. 14 may obtain position information via the communication I/F from an external device including a sensor. In such cases, the acoustic signal processing device need not include a sensor. Here, an external device refers to, for example, audio presentation device 602 described in FIG. 6, or a stereoscopic image reproduction device worn on the listener's head. The sensor includes, for example, a combination of various sensors such as a gyro sensor and an acceleration sensor.

The sensor may, for example, detect an angular velocity of rotation with at least one of three mutually orthogonal axes in the sound space as a rotation axis, or detect an acceleration of displacement with at least one of the three axes as a displacement direction, as a velocity of movement of the head of the listener.

The sensor may, for example, detect a rotation amount with at least one of three mutually orthogonal axes in the sound space as a rotation axis, or detect a displacement amount with at least one of the three axes as a displacement direction, as an amount of movement of the head of the listener. More specifically, the sensor detects the listener's position as 6DoF (position (x, y, z) and angle (yaw, pitch, roll)). The sensor includes a combination of various sensors used for detecting movement, such as a gyro sensor and an acceleration sensor.

The sensor may be implemented by a camera or a Global Positioning System (GPS) receiver, as long as it can detect the listener's position. Position information obtained by performing self-position estimation using Laser Imaging Detection and Ranging (LIDAR) or the like may be used. For example, when the audio signal reproduction system is implemented by a smartphone, the sensor is built into the smartphone.

The sensor may include a temperature sensor such as a thermocouple that detects the temperature of the acoustic signal processing device illustrated in FIG. 14, and a sensor that detects the remaining level of a battery included in or connected to the acoustic signal processing device.

The loudspeaker includes, for example, a diaphragm, a driving mechanism such as a magnet or a voice coil, and an amplifier, and presents the acoustic-processed audio signal as sound to the listener. The loudspeaker operates the driving mechanism in accordance with the audio signal amplified via the amplifier (more specifically, a waveform signal indicating the waveform of sound), and causes the diaphragm to vibrate via the driving mechanism. In this way, the diaphragm vibrating in accordance with the audio signal generates sound waves, the sound waves propagate through the air and are transmitted to the listener's ears, and the listener perceives the sound.

Note that while the acoustic signal processing device illustrated in FIG. 14 has been described as an example where it includes a loudspeaker and presents the acoustic-processed audio signal via the loudspeaker, the means for presenting the audio signal is not limited to the above configuration. For example, the acoustic-processed audio signal may be output to external audio presentation device 602 connected via a communication module. The communication performed by the communication module may be wired or wireless. As another example, the acoustic signal processing device illustrated in FIG. 14 may include a terminal that outputs an analog signal of audio, and the audio signal may be presented from earphones or the like by connecting the earphones cable to the terminal. In this case, audio presentation device 602, such as headphones, earphones, a head-mounted display, neck speakers, wearable speakers worn on the listener's head or a part of the body, or surround speakers configured with a plurality of fixed speakers, reproduces the audio signal.

### Explanation of Functions of Renderer

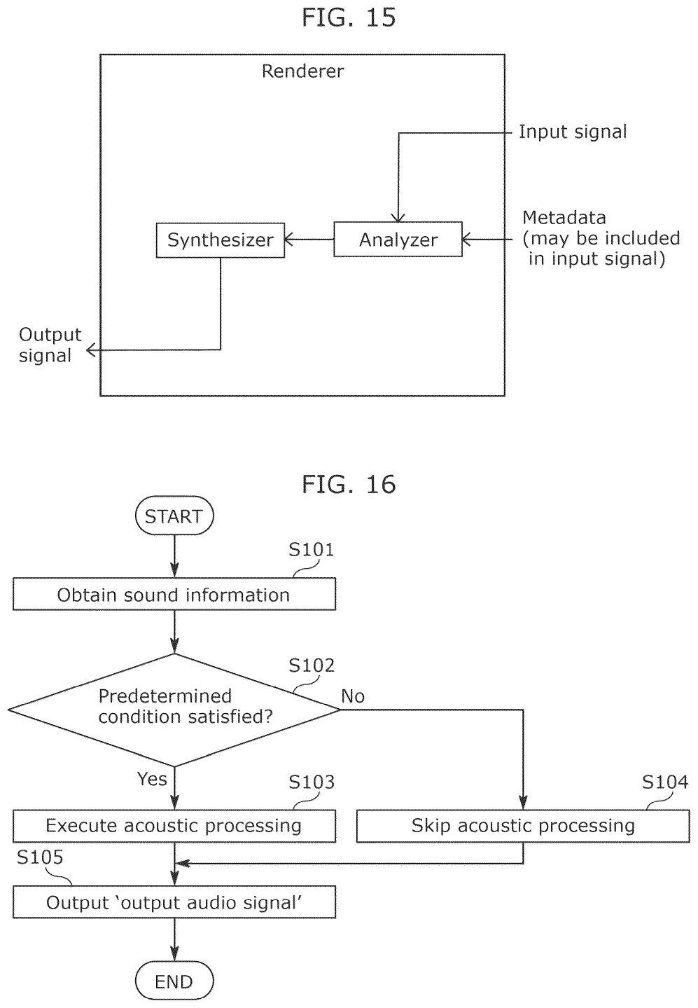

FIG. 15 is a functional block diagram illustrating one example of the detailed configuration of renderers 1103 and 1202 illustrated in FIG. 11 and FIG. 12.

The renderer includes an analyzer and a synthesizer, and adds acoustic processing to sound data included in the input signal, and outputs it.

Next, information included in the input signal will be described.

The input signal includes, for example, spatial information, sensor information, and sound data. The input signal may include a bitstream including sound data and metadata (control information), and in that case, the metadata may include spatial information.

The spatial information is information about a sound space (three-dimensional sound field) created by the three-dimensional sound reproduction system, and includes information related to objects included in the sound space and information related to the listener. Objects include sound source objects that emit sound and become sound sources, and non-sound-emitting objects that do not emit sound. The non-sound-emitting object functions as an obstacle object that reflects sound emitted by the sound source object, but there are also cases where the sound source object functions as an obstacle object that reflects sound emitted by another sound source object.

Information assigned to both sound source objects and non-sound-emitting objects includes position information, geometry information, and the attenuation rate of loudness when the object reflects sound.

The position information is represented by coordinate values of three axes, for example, the X-axis, Y-axis, and Z-axis in Euclidean space, but the position information need not necessarily be three-dimensional information. For example, the position information may be two-dimensional information represented by coordinate values of two axes, the X-axis and Y-axis. The position information of the object is determined at a representative position of the shape expressed by meshes or voxels.

The geometry information may include information related to the surface material.

The object information may include information indicating whether the object belongs to an animate thing and information indicating whether the object is a mobile body. When the object is a mobile body, the position information may move over time, and the changed position information or the amount of change is transmitted to the renderer.

Information related to the sound source object includes, in addition to the information assigned to both sound source objects and non-sound-emitting objects mentioned above, sound data and information necessary for radiating the sound data into the sound space.

Sound data is data that expresses sound perceived by a listener, indicating information such as the frequency and intensity of the sound. The sound data is typically PCM signal, but may also be data compressed using an encoding method such as MP3. In such cases, since the signal needs to be decoded at least before reaching the synthesizer, the renderer may include a decoder (not illustrated). Alternatively, the signal may be decoded in audio data decoder 1102.

At least one item of sound data may be set for one sound source object, and a plurality of items of sound data may be set. Identification information for identifying each item of sound data may be assigned, and the information related to the sound source object may include the identification information of the item of sound data.

The information necessary for radiating sound data into the sound space may include, for example, information on a reference loudness that serves as a reference when reproducing the sound data, information indicating a characteristic of the sound data, information related to the position of the sound source object, information related to the orientation of the sound source object, and information related to the directivity of the sound emitted by the sound source object. The information on the reference loudness may be, for example, the root mean square value of the amplitude of the sound data at the sound source position when radiating the sound data into the sound space, and may be expressed as a floating-point decibel (dB) value.

For example, when the reference loudness is 0 dB, it may indicate that sound is radiated into the sound space from the position indicated by the information related to the position at the same loudness without increasing or decreasing the signal level indicated by the sound data. When it is −6 dB, it may indicate that sound is radiated into the sound space from the position indicated by the information related to the position with the loudness of the signal level indicated by the sound data reduced to approximately half. This information is collectively assigned to one item of sound data or to a plurality of items of sound data.

Information indicating a characteristic of the sound data may be, for example, information related to the loudness of the sound source, and may be information indicating its temporal variation. For example, when the sound space is a virtual conference room and the sound source is a person speaking, the loudness transitions intermittently over short periods of time. This can be expressed even more simply as alternating occurrences of sound-containing portions and silent portions.

When the sound space is a concert hall and the sound source is a performer, the loudness is maintained for a constant duration of time. When the sound space is a battlefield and the sound source is an explosive, the loudness of the explosion sound becomes large for only an instant and then continues to be silent thereafter. Thus, the loudness information of the sound source includes not only information on the magnitude of sound but also information on the transition of sound magnitude, and such information may be used as information indicating a characteristic of the sound data.

Here, the information on the transition of sound magnitude may be data indicating the frequency characteristic in time series. The data may indicate the duration of the interval during which there is sound. The data may indicate the time series of the duration of intervals during which there is sound and the duration of intervals during which there is no sound. The data may enumerate, in chronological order, a plurality of sets of data including a duration during which the amplitude of the sound signal can be considered stationary (can be considered approximately constant) and the amplitude value data of the signal during that duration. The data may be of a duration during which the frequency characteristics of the sound signal can be considered stationary. The data may enumerate, in chronological order, a plurality of sets of data including a duration during which the frequency characteristics of the sound signal can be considered stationary and the frequency characteristic data during that duration.

The data format may be, for example, data indicating the general shape of a spectrogram. The loudness that serves as the standard for the above-mentioned frequency characteristics may be used as the reference loudness. The information on the reference loudness and information indicating a characteristic of the sound data may be used not only to calculate the loudness of the direct sound or reflected sound to be perceived by the listener, but also for selection processing to determine whether or not to cause the listener to perceive them. Other examples of information indicating a characteristic of the sound data and specific ways in which it is used for selection processing will be described later.

Information regarding orientation is typically expressed in terms of yaw, pitch, and roll. Alternatively, the rotation may be expressed in terms of azimuth (yaw) and elevation (pitch), omitting roll rotation. The orientation information may change over time, and when changed, it is transmitted to the renderer.

The information related to the listener is information about the position information and orientation of the listener in the sound space. The position information is represented by positions on the X-, Y-, and Z-axes in Euclidean space, but need not necessarily be three-dimensional information, and may be two-dimensional information. Information regarding orientation is typically expressed in terms of yaw, pitch, and roll. Alternatively, the rotation may be expressed in terms of azimuth (yaw) and elevation (pitch), omitting roll rotation. The position information and orientation information may change over time, and when changed, they are transmitted to the renderer.

The sensor information includes the rotation amount or displacement amount detected by the sensor worn by the listener, and the position and orientation of the listener. The sensor information is transmitted to the renderer, and the renderer updates the information on the position and orientation of the listener based on the sensor information. The sensor information may be, for example, position information obtained by performing self-position estimation using GPS, a camera, or Laser Imaging Detection and Ranging (LIDAR) on the mobile terminal. Additionally, information obtained from an external source through a communication module, other than from a sensor, may be detected as sensor information. Information indicating the temperature of the acoustic processing device, and information indicating the remaining level of the battery may be obtained from the sensor. The computational resources (CPU capability, memory resources, PC performance) of the acoustic processing device or audio signal presentation device may be obtained in real time.

The analyzer performs functions equivalent to those of obtainer 111 in the above example. Stated differently, the input signal is analyzed, and information necessary for processor 121 is obtained.

The synthesizer performs functions equivalent to those of processor 121 and signal outputter 141 in the above example. The direct sound is generated by processing the input audio signal based on the audio signal of the direct sound and information on the arrival time and arrival loudness of the direct sound calculated by the analyzer. The reflected sound is generated by processing the input audio signal based on information on the arrival time and arrival loudness of the reflected sound calculated by the analyzer. The synthesizer synthesizes and outputs the generated direct sound and reflected sound.

### Operations

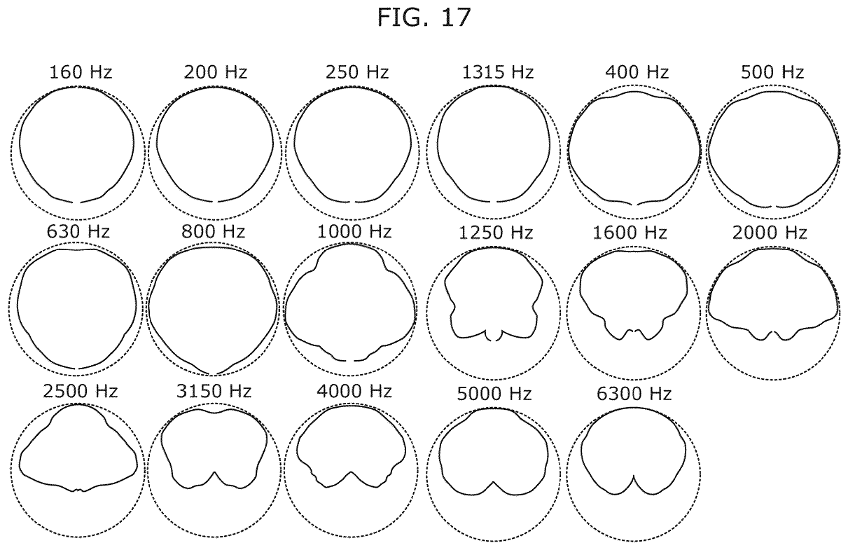

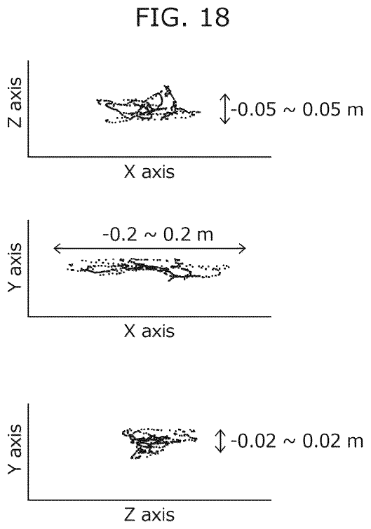

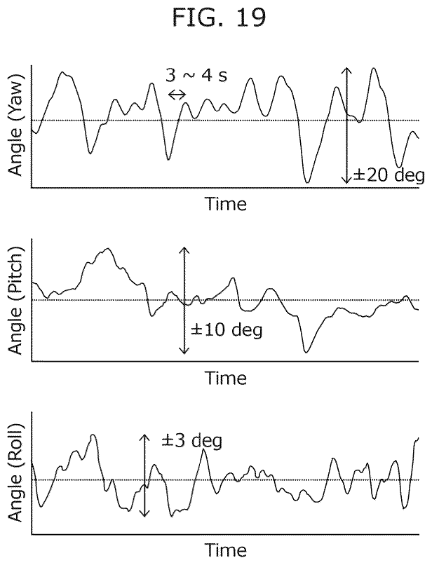

Next, operations performed by acoustic reproduction system 100 described above will be explained with reference to FIG. 16 through FIG. 19. FIG. 16 is a flowchart illustrating operations performed by an acoustic reproduction system according to an embodiment. FIG. 17 is a diagram for explaining frequency characteristics of acoustic processing according to an embodiment. FIG. 18 is a diagram for explaining the magnitude of fluctuation in acoustic processing according to an embodiment. FIG. 19 is a diagram for explaining the period and angle of fluctuation in acoustic processing according to an embodiment.

Note that before each step illustrated in FIG. 16, it is explained that the settings are configured such that acoustic processing is to be executed based on a determination according to the control information. As illustrated in FIG. 16, first, obtainer 111 obtains sound information (audio signal) (S101). Next, determiner 122 determines whether to execute the acoustic processing. More specifically, determiner 122 reads out a predetermined condition stored in storage 123, and determines whether to execute the acoustic processing by determining whether the predetermined condition is satisfied (S102).

Hereinafter, several examples of the predetermined condition will be given.

First, when a change in sound pressure of a predetermined sound in the time domain in the obtained sound information is less than or equal to a predetermined threshold, it is considered that the predetermined sound in the sound information does not include fluctuation, and it is appropriate to add fluctuation. If a condition related to a change in sound pressure in the time domain is set as a condition that can be considered appropriate for performing acoustic processing, the predetermined condition can be determined to be satisfied when a change in sound pressure in the time domain is less than or equal to the above-mentioned threshold.

FIG. 17 illustrates the difference in distances at which sounds of each frequency reach the same sound pressure in each direction in the horizontal plane when emitted from a sound source (center of each dashed circle). Each diagram in FIG. 17 illustrates the difference in sound propagation characteristics in each direction at that frequency, and it can be said that the more distorted the shape, the more easily the fluctuation of the sound source is reflected. Stated differently, to determine the fluctuation of the sound source based on changes in sound pressure in the time domain, it is preferable to decompose the predetermined sound by frequency and determine whether changes in sound pressure in the time domain are exhibited at frequencies where the fluctuation of the sound source is more easily reflected. For example, as illustrated in FIG. 17, for frequencies of 1000 Hz or higher, the shape changes from circular to distorted, and it can be said that fluctuations are more easily reflected. Moreover, as illustrated in FIG. 17, for frequencies of 4000 Hz or higher, the shape changes from circular to an even more distorted form, and it can be said that fluctuations are even more easily reflected.

Conversely, as illustrated in FIG. 17, it can also be said that when applying fluctuation, executing acoustic processing at frequencies below 1000 Hz makes it difficult to obtain the effect of fluctuation. Therefore, in acoustic processing, acoustic processing may be executed only for frequencies of 1000 Hz or higher, or acoustic processing may be executed only for frequencies of 4000 Hz or higher. Alternatively, acoustic processing may be executed such that the larger the frequency, the larger the fluctuation becomes.

The positional relationship between the sound collection device and the sound source is estimated using the sound pressure at a predetermined position or of a predetermined sound in the obtained sound information, and when the estimated positional relationship is less than or equal to a predetermined threshold, it is considered that a close-talking sound collection device such as a headset microphone is being used, so it is considered that the predetermined sound in the sound information does not include fluctuation, and it is appropriate to add fluctuation. If a condition related to the estimated positional relationship is set as a condition that can be considered appropriate for performing acoustic processing, the predetermined condition can be determined to be satisfied when a positional relationship less than or equal to the above-mentioned threshold is indicated.

FIG. 18 illustrates the results of plotting human head movements in three axes of X, Y, and Z. In FIG. 18, a plot of head movements in the Y-axis direction (up-down direction) is illustrated in the upper section, a plot of head movements in the Z-axis direction (front-back direction) is illustrated in the middle section, and a plot of head movements in the X-axis direction (left-right direction) is illustrated in the lower section. As illustrated in FIG. 18, it can be seen that the human head has movements of ±0.2 m in the X-axis direction (left-right direction), ±0.02 m in the Y-axis direction (up-down direction), and ±0.05 m in the Z-axis direction (front-back direction).

Thus, if there is no movement of such magnitude, it is considered that the estimated positional relationship is less than or equal to a predetermined threshold, such as when a close-talking sound collection device like a headset microphone is being used.

Conversely, as illustrated in FIG. 18, when applying fluctuation, acoustic processing may be executed to reproduce movements of ±0.2 m in the X-axis direction (left-right direction), ±0.02 m in the Y-axis direction (up-down direction), and ±0.05 m in the Z-axis direction (front-back direction). In this way, acoustic processing can also be executed under processing conditions that are dependent on the positional relationship between the sound collection device and the sound source.

FIG. 19 illustrates the results of plotting rotation angles of human head movements in three rotational axes of Yaw, Pitch, and Roll. FIG. 19 illustrates the rotation angle in the Yaw angle in the upper section, the rotation angle in the Pitch angle in the middle section, and the rotation angle in the Roll angle in the lower section. As illustrated in FIG. 19, it can be seen that the human head has rotations of ±20 degrees in the Yaw angle, ±10 degrees in the Pitch angle, and ±3 degrees in the Roll angle, with a period of 3 to 4 seconds.

Thus, if there is no movement of such period and angle, it is considered that the estimated positional relationship is less than or equal to a predetermined threshold, such as when a close-talking sound collection device like a headset microphone is being used.

Conversely, as illustrated in FIG. 19, when applying fluctuation, acoustic processing may be executed to reproduce rotations of ±20 degrees in the Yaw angle, ±10 degrees in the Pitch angle, and ±3 degrees in the Yaw angle, with a period of 3 to 4 seconds. In this way, acoustic processing can also be executed under processing conditions that are dependent on the positional relationship between the sound collection device and the sound source.

The sound collection situation information regarding conditions at the time of sound collection is used, and when the reverberation level and/or noise level indicated in the sound collection situation information is less than or equal to a predetermined threshold, it is considered that a close-talking sound collection device such as a headset microphone is being used, so it is considered that the predetermined sound in the sound information does not include fluctuation, and it is appropriate to add fluctuation. If a condition related to the reverberation level and/or noise level indicated in the sound collection situation information is set as a condition that can be considered appropriate for performing acoustic processing, the predetermined condition can be determined to be satisfied when the reverberation level and/or noise level is less than or equal to the above-mentioned threshold.

Additionally, information about the sound collection equipment used for sound collection (such as information identifying the device like model numbers, or information indicating device characteristics like whether fluctuation addition is necessary) may be used to determine that a predetermined condition is satisfied when such information indicates that a close-talking sound collection device like a headset microphone is being used.

Returning to FIG. 16, when determiner 122 determines that the predetermined condition is satisfied (Yes in S102), executor 124 executes the acoustic processing (S103). However, when determiner 122 determines that the predetermined condition is not satisfied (No in S102), executor 124 skips the acoustic processing (S104). Signal outputter 141 generates and outputs an output audio signal (S105).

### Other Examples

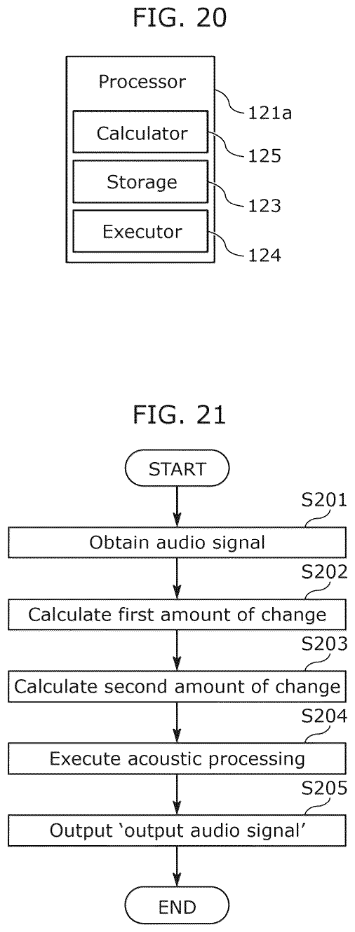

Hereinafter, an acoustic reproduction system according to another example of the embodiment will be described with reference to FIG. 20 and FIG. 21. FIG. 20 is a block diagram illustrating the functional configuration of a processor according to another example of the embodiment. FIG. 21 is a flowchart illustrating operations performed by an acoustic processing device according to another example of the embodiment. Note that in the explanation of the following other examples, some explanations of the above embodiment may be omitted by replacing “sound collection device” with “listening point”.

The acoustic reproduction system according to another example of the embodiment differs from acoustic reproduction system 100 of the above-mentioned embodiment in that it includes processor 121a instead of processor 121.

Processor 121a includes calculator 125 instead of determiner 122. Calculator 125 calculates a first amount of change and a second amount of change. The first amount of change is an amount of change based on an instruction to change the relative position between the listening point and the sound source object, and corresponds to the amount of movement in what is known as VR space. When limited to the virtual sound space, it is an amount of change of the relative position between the listening point and the sound source object accompanied by the movement of the listening point. By obtaining the detection result from detector 103 functioning as a sensor, the first amount of change, i.e., an instruction for changing the relative position corresponding to the point in time of the detection result is obtained. That is, in the present example, obtainer 111 (particularly sensing information inputter 114) receives an instruction including the first amount of change.

In the present embodiment, in addition to the change in the relative position, since a change in the listening point due to fluctuation occurs, the first amount of change and the second amount of change are calculated separately. Note that by setting the second amount of change to 0, it is possible to differentiate between executing and skipping acoustic processing without going through processing by determiner 122. The second amount of change may be calculated based on the detection result, or may be calculated independently of the detection result. For example, the second amount of change may be calculated by a function using the rate of change of the relative position between the sound source object and the listening point indicated in the detection result, or the amount of change, i.e., the first amount of change. Alternatively, the second amount of change may be uniquely calculated without using (independently of) the rate of change of the relative position between the sound source object and the listening point, or the amount of change, i.e., the first amount of change, simply based on information attached to the content at the time of content creation, such as control information and sound collection situation information.

When the first amount of change is large, there may be cases where the sound source object is moving significantly relative to a stationary listening point. In such a case, the larger the first amount of change, the more natural it is for the fluctuation of that sound source object to be larger. Stated differently, the larger the first amount of change, the larger the second amount of change should be. Therefore, in acoustic processing, the second amount of change, which corresponds to the magnitude of fluctuation, should increase as the first amount of change increases, in accordance with the first amount of change.

However, in acoustic processing, as an example where the second amount of change, which corresponds to the magnitude of fluctuation, varies according to the first amount of change, conversely, it may be appropriate to decrease the second amount of change (for example, make it 0) as the first amount of change increases. More specifically, for example, when the first amount of change is large (or the speed of change in relative position is fast), imparting fluctuation does not significantly increase the sense of realism. This is because the changes due to fluctuation and the changes in relative position synchronize and overlap, or cancel each other out, making it difficult for the listener to perceive that fluctuation has been imparted. In such cases, the second amount of change should decrease (for example, 0) with an increase in the first amount of change.

Hereinafter, operations performed by acoustic the reproduction system according to the present example will be described. Note that before each step illustrated in FIG. 21, it is explained that the settings are configured such that acoustic processing is to be executed based on a determination according to the control information. As illustrated in FIG. 21, first, obtainer 111 obtains sound information (audio signal) (S201). Next, calculator 125 calculates the first amount of change (S202). Calculator 125 then calculates the second amount of change (S203). Whether to execute the acoustic processing (whether to impart fluctuation) can be set by determining whether to calculate the second amount of change as 0. Executor 124 executes acoustic processing of changing the relative position by the first amount of change, and repeatedly changing the relative position in the time domain by the second amount of change (S204). Thereafter, signal outputter 141 generates and outputs an output audio signal (S205).

### Other Embodiments

While exemplary embodiments have been described above, the present disclosure is not limited to the above-described embodiments.

For example, the acoustic reproduction system described in the above embodiments may be implemented as a single device including all elements, or may be implemented by a plurality of devices, with each function allocated to the devices and these devices cooperating with each other. In the latter case, an acoustic processing device such as a smartphone, tablet terminal, or personal computer (PC) may be used as a device corresponding to the acoustic processing device. For example, in acoustic reproduction system 100 having a function as a renderer that generates an acoustic signal added with an acoustic effect, a server may handle all or part of the functions of the renderer. Stated differently, all or part of obtainer 111, processor 121, and signal outputter 141 may be implemented in a server not shown in the figure. In such case, acoustic reproduction system 100 is implemented by combining an acoustic processing device such as a computer or smartphone, an audio presentation device such as a head-mounted display (HMD) or earphones worn by user 99, and a server not illustrated in the figures. Note that the computer, audio presentation device, and server may be communicably connected on the same network or may be connected on different networks. When connected on different networks, the possibility of communication delays increases, so a configuration may be adopted in which processing on the server is permitted only when the computer, audio presentation device, and server are communicably connected on the same network. Based on the amount of data in the bitstream received by acoustic reproduction system 100, a configuration in which whether or not all or part of the renderer's functions are to be handled by the server is determined may be implemented.

The acoustic reproduction system according to the present disclosure can also be implemented as an acoustic processing device that is connected to a reproduction device including only drivers, and that only reproduces output sound signals generated based on obtained sound information for the reproduction device. In such cases, the acoustic processing device may be implemented as hardware including dedicated circuits, or may be implemented as software for causing a general-purpose processor to execute specific processing.

In the above embodiments, processing executed by a specific processor may be executed by another processor. The order of a plurality of processes may be changed, and a plurality of processes may be executed in parallel.

Moreover, in the above embodiments, each element may be realized by executing a software program suitable for the element. Each of the elements may be realized by means of a program executing unit, such as a central processing unit (CPU) or a processor, reading and executing the software program recorded on a recording medium such as a hard disk or a semiconductor memory.

Each of the structural elements may be implemented by hardware. For example, each element may be a circuit (or an integrated circuit). These circuits may constitute one circuit as a whole, or may be separate circuits. These circuits may each be a general-purpose circuit or a dedicated circuit.

General or specific aspects of the present disclosure may be realized as a device, a method, an integrated circuit, a computer program, or a computer-readable recording medium such as a CD-ROM. General or specific aspects of the present disclosure may be realized as any given combination of a device, an apparatus, a method, an integrated circuit, a computer program, and a recording medium.

For example, the present disclosure may be implemented as an audio signal reproduction method executed by a computer, or may be implemented as a program for causing a computer to execute an audio signal reproduction method. The present disclosure may be implemented as a computer-readable non-transitory recording medium having the program recorded thereon.

Embodiments arrived at by a person skilled in the art making various modifications to any one of the embodiments, or embodiments realized by arbitrarily combining elements and functions in the embodiments which do not depart from the essence of the present disclosure are also included in the present disclosure.

Note that the encoded sound information in the present disclosure can be rephrased as a bitstream including a sound signal, which is information about a predetermined sound reproduced by acoustic reproduction system 100, and metadata, which is information about a localization position when localizing the sound image of the predetermined sound at a predetermined position in a three-dimensional sound field. For example, the sound information may be obtained by acoustic reproduction system 100 as a bitstream encoded in a predetermined format such as MPEG-H 3D Audio (ISO/IEC 23008-3). As one example, the encoded sound signal includes information about a predetermined sound that is reproduced by acoustic reproduction system 100. Here, the predetermined sound is a sound emitted by a sound source object existing in the three-dimensional sound field or an environmental sound, and can include, for example, mechanical sounds, or voices of animals including humans. Note that when there are a plurality of sound source objects in the three-dimensional sound field, acoustic reproduction system 100 obtains a plurality of sound signals respectively corresponding to the plurality of sound source objects.

Metadata is, for example, information used for controlling acoustic processing on the sound signal in acoustic reproduction system 100. The metadata may be information used for describing a scene expressed in the virtual space (three-dimensional sound field). Here, the term “scene” refers to an aggregate of all elements representing three-dimensional images and acoustic events in the virtual space, which are modeled in acoustic reproduction system 100 using metadata. Thus, metadata herein may include not only information for controlling acoustic processing, but also information for controlling video processing. The metadata may of course include information for controlling only acoustic processing or video processing, or may include information for use in controlling both. In the present disclosure, the bitstream obtained by acoustic reproduction system 100 may include such metadata. Alternatively, acoustic reproduction system 100 may obtain metadata separately from the bitstream, as described later.

Acoustic reproduction system 100 generates virtual acoustic effects by performing acoustic processing on the sound signal using metadata included in the bitstream and additionally obtained interactive position information of user 99. For example, acoustic effects such as early reflected sound generation, late reverberation sound generation, diffracted sound generation, distance attenuation effect, localization, sound image localization processing, or Doppler effect may be added. Information for switching on or off all or part of the acoustic effects may be added as metadata.

Note that the entire metadata or part of the metadata may be obtained from somewhere other than a bitstream that includes sound information. For example, metadata for controlling an acoustic sound or metadata for controlling a video may be obtained from somewhere other than from a bitstream or both may be obtained from somewhere other than from a bitstream.

When metadata for controlling video is included in the bitstream obtained by acoustic reproduction system 100, acoustic reproduction system 100 may include a function to output metadata that can be used for controlling video to a display device that displays images, or to a stereoscopic image reproduction device that reproduces stereoscopic images.

As an example, encoded metadata includes information about a three-dimensional sound field including a sound source object that emits sound and an obstacle object and information about a localization position when the sound image of the sound is localized at a predetermined position in the three-dimensional sound field (i.e., the sound is perceived as arriving from a predetermined direction), namely, information about the predetermined direction. Here, an obstacle object is an object that can affect the sound perceived by user 99, for example, by blocking or reflecting the sound, during the period until the sound emitted by the sound source object reaches user 99. Obstacle objects can include not only stationary objects but also animals such as humans or mobile bodies such as machines. When there are a plurality of sound source objects in the three-dimensional sound field, for any given sound source object, the other sound source objects can become obstacle objects. Non-emitting sound source objects such as building material and inanimate objects and sound emitting sound source objects can both be obstacle objects.

The metadata may include, as spatial information including the metadata, not only the shape of the three-dimensional sound field, but also information representing the shape and position of obstacle objects existing in the three-dimensional sound field, and the shape and position of sound source objects existing in the three-dimensional sound field. The three-dimensional sound field may be either a closed space or an open space, and the metadata includes, for example, information representing the reflectivity of structures that can reflect sound in the three-dimensional sound field, such as floors, walls, or ceilings, and the reflectivity of obstacle objects present in the three-dimensional sound field. As used herein, reflectance is the ratio of energy of reflected sound to incident sound, and is set for each frequency band of the sound. The reflectance may be set uniformly regardless of the frequency band of the sound. If the three-dimensional sound field is an open space, parameters such as a uniformly set attenuation rate, diffracted sound, or early reflected sound may be used.

In the above description, reflectance is stated as a parameter with regard to an obstacle object or a sound source object included in metadata, but the metadata may include information other than reflectance. For example, information on the material of an object may be included as metadata related to both of a sound source object and a non-emitting sound source object. Specifically, metadata may include a parameter such as a diffusion factor, a transmittance, or an acoustic absorptivity.

Information related to the sound source object may include loudness, radiation characteristics (directivity), reproduction conditions, the number and types of sound sources emitted from a single object, or information specifying the sound source region in the object. The reproduction condition may determine that a sound is, for example, a sound that is continuously being emitted or is emitted at an event. The sound source region in the object may be determined based on the relative relationship between the position of user 99 and the position of the object, or may be determined with reference to the object. When determined based on the relative relationship between the position of user 99 and the position of the object, with respect to the plane along which user 99 is looking at the object, user 99 can be made to perceive that sound X is emitted from the right side of the object and sound Y is emitted from the left side of the object as seen from user 99. When determined with reference to the object, regardless of the direction in which user 99 is looking, it is possible to fixate which sound is emitted from which region of the object. For example, user 99 can be made to perceive that a high-pitched sound is emitted from the right side and a low-pitched sound is emitted from the left side when viewing the object from the front. In this case, when user 99 moves around to the back of the object, user 99 can be made to perceive that a low-pitched sound is emitted from the right side and a high-pitched sound is emitted from the left side as seen from the back.

The time until an initial reflected sound arrives, the reverberation time, or the ratio between the direct sound and the diffused sound, for instance, can be included as metadata related to a space. When the ratio between the direct sound and the diffused sound is zero, user 99 can be made to perceive only the direct sound.

Information indicating the position and orientation of user 99 in the three-dimensional sound field may be included in the bitstream as metadata as an initial setting, or may not be included in the bitstream. When information indicating the position and orientation of user 99 is not included in the bitstream, information indicating the position and orientation of user 99 is obtained from information other than the bitstream. For example, regarding position information of user 99 in a VR space, the position information may be obtained from an application providing VR content. Regarding position information of user 99 for presenting sound as AR, position information obtained by performing self-position estimation using GPS, a camera, or Laser Imaging Detection and Ranging (LIDAR) on the mobile terminal, for example, may be used. Note that the sound signal and metadata may be stored in a single bitstream or may be separately stored in a plurality of bitstreams. Similarly, the sound signal and metadata may be stored in a single file or may be separately stored in a plurality of files.

When the sound signal and metadata are separately stored in a plurality of bitstreams, information indicating other relevant bitstreams may be included in one or some of the plurality of bitstreams in which the sound signal and metadata are stored. Information indicating other relevant bitstreams may be included in the metadata or control information of each bitstream of the plurality of bitstreams in which the sound signal and metadata are stored. When the sound signal and metadata are separately stored in a plurality of files, information indicating other relevant bitstreams or files may be included in one or some of the plurality of files in which the sound signal and metadata are stored. Information indicating other relevant bitstreams or files may be included in the metadata or control information of each bitstream of the plurality of bitstreams in which the sound signal and metadata are stored.

Here, the related bitstream or the related file is a bitstream or a file that may be simultaneously used in acoustic processing, for example. Information indicating other relevant bitstreams may be collectively described in the metadata or control information of one bitstream of the plurality of bitstreams in which the sound signal and metadata are stored, or may be separately described in the metadata or control information of two or more bitstreams of the plurality of bitstreams in which the sound signal and metadata are stored. Similarly, information indicating other relevant bitstreams or files may be collectively described in the metadata or control information of one file of the plurality of files in which the sound signal and metadata are stored, or may be separately described in the metadata or control information of two or more files of the plurality of files in which the sound signal and metadata are stored. A control file that collectively describes information indicating other relevant bitstreams or files may be generated separately from the plurality of files in which the sound signal and metadata are stored. In such cases, the control file need not store the sound signal and metadata.

Here, information indicating a relevant other bitstream or file may be an identifier indicating the other bitstream, a file name showing the other file, a uniform resource locator (URL), or a uniform resource identifier (URI), for instance. In this case, obtainer 111 identifies or obtains a bitstream or a file, based on information indicating a relevant other bitstream or file. Information indicating other relevant bitstreams may be included in the metadata or control information of at least some of the plurality of bitstreams in which the sound signal and metadata are stored, and information indicating other relevant files may be included in the metadata or control information of at least some of the plurality of files in which the sound signal and metadata are stored. Here, a file that includes information indicating a relevant bitstream or file may be a control file such as a manifest file for use in distributing content, for example.

### INDUSTRIAL APPLICABILITY

The present disclosure is useful for acoustic reproduction, such as making a user perceive three-dimensional sound.

1. An acoustic processing method comprising:
obtaining an audio signal generated by collecting sound emitted from a sound source using a sound collection device;
executing, on the audio signal, acoustic processing that repeatedly changes a relative position between the sound collection device and the sound source in a time domain; and
outputting an output audio signal on which the acoustic processing has been executed.

2. The acoustic processing method according to claim 1, wherein
the executing includes:
determining whether a change in sound pressure in the time domain of the audio signal satisfies a predetermined condition regarding the change;
executing the acoustic processing when the predetermined condition is determined to be satisfied; and
skipping the acoustic processing when the predetermined condition is determined not to be satisfied.

3. The acoustic processing method according to claim 1, wherein
the executing includes:
estimating a positional relationship between the sound collection device and the sound source using the audio signal;
determining whether the positional relationship estimated satisfies a predetermined condition regarding the positional relationship;
executing the acoustic processing when the predetermined condition is determined to be satisfied; and
skipping the acoustic processing when the predetermined condition is determined not to be satisfied.

4. The acoustic processing method according to claim 1, wherein
the audio signal includes sound collection situation information regarding a condition at time of sound collection, and
the executing includes:
determining whether the sound collection situation information included in the audio signal satisfies a predetermined condition regarding the sound collection situation information;
executing the acoustic processing when the predetermined condition is determined to be satisfied; and
skipping the acoustic processing when the predetermined condition is determined not to be satisfied.

5. The acoustic processing method according to claim 1, wherein
the executing includes:
estimating a positional relationship between the sound collection device and the sound source using the audio signal; and
executing the acoustic processing under a processing condition dependent on the positional relationship estimated.

6. An acoustic processing method for outputting an output audio signal that causes a sound emitted from a sound source object in a virtual sound space to be perceived as if heard at a listening point in the virtual sound space, the acoustic processing method comprising:
obtaining an audio signal including the sound emitted from the sound source object;
receiving an instruction to change a relative position between the listening point and the sound source object, including a first amount of change by which the relative position changes according to the instruction;
executing, on the audio signal, acoustic processing that changes the relative position by the first amount of change, and repeatedly changes the relative position in a time domain by a second amount of change; and
outputting the output audio signal on which the acoustic processing has been executed.

7. The acoustic processing method according to claim 6, wherein
the sound source object simulates a user in a real space,
the acoustic processing method further comprises obtaining a detection result from a sensor provided in the real space that detects the user, and
the second amount of change is calculated based on the detection result.

8. The acoustic processing method according to claim 6, wherein
the sound source object simulates a user in a real space,
the acoustic processing method further comprises obtaining a detection result from a sensor provided in the real space that detects the user, and
the second amount of change is calculated independently of the detection result.

9. The acoustic processing method according to claim 6, wherein
the second amount of change is calculated independently of the first amount of change.

10. The acoustic processing method according to claim 6, wherein
the second amount of change is calculated to increase as the first amount of change increases.

11. The acoustic processing method according to claim 6, wherein
the second amount of change is calculated to increase as the first amount of change decreases.

12. The acoustic processing method according to claim 1, further comprising:
obtaining control information for the audio signal, wherein
in the executing, the acoustic processing is executed when the control information indicates to execute the acoustic processing.

13. An acoustic processing device comprising:
an obtainer that obtains an audio signal generated by collecting sound emitted from a sound source using a sound collection device;
a processor that executes, on the audio signal, acoustic processing that repeatedly changes a relative position between the sound collection device and the sound source in a time domain; and
an outputter that outputs an output audio signal on which the acoustic processing has been executed.

14. A non-transitory computer-readable recording medium for use in a computer, the recording medium having a computer program recorded thereon for causing the computer to execute the acoustic processing method according to claim 1.
